(19) United States
(12) Patent Application Publication
(10) Pub. No.: US 2025/0159536 A1
(43) Pub. Date: May 15, 2025

(54) METHOD AND APPARATUS FOR TRANSMITTING AND RECEIVING CHANNEL STATE INFORMATION AND COMMUNICATION SYSTEM

(71) Applicant: FUJITSU LIMITED, Kawasaki-shi (JP)

(72) Inventors: Qun ZHANG, Beijing (CN); Xin WANG, Beijing (CN); Gang SUN, Beijing (CN); Lei ZHANG, Beijing (CN)

(73) Assignee: FUJITSU LIMITED, Kawasaki-shi (JP)

(21) Appl. No.: 19/024,723

(22) Filed: Jan. 16, 2025

Related U.S. Application Data
(63) Continuation of application No. PCT/CN2023/076523, filed on Feb. 16, 2023.

(30) Foreign Application Priority Data
Sep. 27, 2022 (WO) PCT/CN2022/121843

(51) Int. Cl. H04W 24/10

(52) U.S. Cl. CPC H04W 24/10

(57) ABSTRACT

An apparatus for transmitting channel state information (CSI), applicable to a terminal equipment, includes: a first generator configured to generate at least a portion of information of channel state information (CSI) according to an artificial intelligence model; and first omitting processor circuitry configured to omit first information of the channel state information according to priority orders of the channel state information and/or first configuration information.

### CROSS-REFERENCE TO RELATED APPLICATION

This application is a continuation application of International Patent Application PCT/CN2023/076523 filed on Feb. 16, 2023, which claims priority of International Patent Application PCT/CN2022/121843 filed on Sep. 27, 2022, the entire contents of each are incorporated herein by reference.

### TECHNICAL FIELD

This disclosure relates to the field of communication technologies.

### BACKGROUND

The multiple-input multiple-output (MIMO) technology is one of key technologies for 5G mobile communications. MIMO is able to provide higher channel capacities, but realization of the benefits is dependent on whether accurate channel state information is able to be acquired. In the MIMO technology, a terminal equipment measures spatial channels and feeds back channel state information (CSI) to a network device. The network devices may select a precoding matrix appropriate for downlink transmission of the terminal equipment according to the channel state information reported by the terminal equipment, thereby minimizing a probability of error in receiving bits by the terminal equipment as much as possible.

A process for generating and feeding back channel state information may be summarized as follows. The network device transmits channel state information reference signals (CSI-RSs) to terminal equipments, and the terminal equipments estimate channels based on the received CSI-RSs to obtain estimation of spatial channel matrices. The terminal equipments further acquire CSI by utilizing the estimated spatial channels. In the New Radio (NR) technology, a mode for feeding back the CSI is implicit feedback, that is, the terminal equipments feed back the CSI by recommending transmission parameters to the network device, wherein the transmission parameters include a channel state indicator (CQI), a precoding matrix indicator (PMI), a CSI-RS resource indicator (CRI), a synchronization signal block resource indicator (SSBRI), a layer indicator (LI), a rank indicator (RI) and physical layer RSRP (L1-RSRP). A base station may perform downlink transmission by directly using the parameters recommended by the terminal equipments, or it may not use the recommended parameters.

In a frequency division duplex (FDD) system, for a downlink, when a network device performs precoding by using information of a downlink channel, a terminal equipment is needed to feed back downlink channel state information to the network device via an uplink. However, as the information of the downlink channel is directly proportional to the number of antennas of the network device, in s scenario of massive MIMO, a huge number of antennas of the network device will lead to a very large amount of feedback of channel state information of the downlink channel. The Third generation portionnership Project (3GPP) has designed enhanced codebooks (such as Type II codebook) for downlink feedback, in which the amount of feedback of the channel state information is reduced through frequency domain compression. However, for valuable uplink resources, there is still a need to further reduce an amount of uplink feedback.

With the development of artificial intelligence/machine learning (AI/ML) technologies, applying the artificial intelligence/machine learning technologies to physical layers of wireless communication to solve difficulties of related methods has become a current technological direction.

FIG. 1 is a schematic diagram of performing CSI feedback based on AI/ML. As shown in FIG. 1, in operation 101, a terminal equipment side performs processing by using an AI/ML-based CSI generation portion to obtain compressed CSI, and a network device receives the CSI via an air interface; and in operation 102, the network device performs processing on the received CSI by using an AI/ML-based CSI reconstruction portion to obtain recovered CSI.

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY OF THE DISCLOSURE

In performing CSI feedback by using codebooks, priorities may be set for the CSI, and a terminal equipment may feed back the CSI in an order of high priority levels (priority reporting levels) (for example, numeral values thereof are small) to low priority levels (for example, numeral values thereof are large). In addition, in a case where a portion of CSI needs to be omitted, the terminal equipment may omit CSI in a priority order, wherein the priority order is an order set according to the priority levels. For example, an order of numeral values of the priority levels from high to low is the priority order, that is, the higher a numeral value of a priority level, the earlier CSI is omitted.

It was found by the inventors of this disclosure that a technology of how to omit CSI generated based on AI/ML is not concerned in the related art. Hence, when a terminal equipment omits at least some information in the CSI generated based on AI/ML, an ambiguity may arise when the network device reads the received CSI. Furthermore, for the CSI generated based on AI/ML, how to set priority orders of the CSI is also not concerned in the related art.

In order to solve at least one of the above problems or other similar problems, embodiments of this disclosure provides a method and apparatus for transmitting and receiving channel state information and a communication system, in which first information of CSI generated based on AI/ML is omitted according to a priority order of the CSI and/or first configuration information, thereby omitting the CSI generated based on AI/ML, and avoiding an ambiguity possibly generated when a network device reads the CSI.

According to one aspect of the embodiments of this disclosure, there is provided an apparatus for transmitting channel state information (CSI), applicable to a terminal equipment, the apparatus including:
a first generating unit configured to generate at least a portion of information of channel state information (CSI) according to an artificial intelligence model; and
a first omitting unit configured to omit first information of the channel state information according to priority orders of the channel state information and/or first configuration information.

According to another aspect of the embodiments of this disclosure, there is provided an apparatus for transmitting channel state information (CSI), applicable to a terminal equipment, the apparatus including:
a second generating unit configured to generate at least a portion of information of channel state information (CSI) based on an artificial intelligence model, wherein the channel state information has priority orders.

According to a further aspect of the embodiments of this disclosure, there is provided an apparatus for transmitting channel state information (CSI), applicable to a terminal equipment, the apparatus including a first transmitting unit, the first transmitting unit being configured to:
transmit at least a portion of information of first channel state information (CSI); and
transmit indication information, the indication information being used to indicate an expanding mode of the at least a portion of information of first channel state information (CSI).

An advantage of the embodiments of this disclosure exists in that the terminal equipment is able to omit the CSI generated based on AI/ML, thereby avoiding an ambiguity possibly generated when the network device reads the CSI.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the spirits and scope of the terms of the appended claims.

Features that are described and/or illustrated with respect to one embodiments may be used in the same way or in a similar way in one or more other embodiments and/or in combination with or instead of the features of the other embodiments.

It should be emphasized that the term “comprises/comprising/includes/including” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiments of the disclosure may be combined with elements and features depicted in one or more additional drawings or embodiments. Moreover, in the drawings, like reference numerals designate corresponding parts throughout the several views and may be used to designate like or similar parts in more than one embodiment.

FIG. 1 is schematic diagram of performing CSI feedback based on AI/ML;

FIG. 2 is a schematic diagram of a communication system of this disclosure;

FIG. 3 is a schematic diagram of a method for transmitting channel state information (CSI) of a first aspect of this disclosure;

FIG. 4 is a schematic diagram of a method for transmitting channel state information (CSI) of a second aspect of this disclosure;

FIG. 5 is a schematic diagram of a method for transmitting channel state information (CSI) of a third aspect of this disclosure;

FIG. 6 is a schematic diagram of a method for receiving channel state information of an embodiment of a fourth aspect of this disclosure;

FIG. 7 is a schematic diagram of a method for receiving channel state information of an embodiment of a fifth aspect of this disclosure;

FIG. 8 is a schematic diagram of a method for receiving channel state information of an embodiment of a sixth aspect of this disclosure;

FIG. 9 is a schematic diagram of an apparatus for transmitting channel state information of an embodiment of a seventh aspect of this disclosure;

FIG. 10 is a schematic diagram of an apparatus for transmitting channel state information of an embodiment of an eighth aspect of this disclosure;

FIG. 11 is a schematic diagram of an apparatus for transmitting channel state information of an embodiment of a ninth aspect of this disclosure;

FIG. 12 is a schematic diagram of an apparatus for receiving channel state information of an embodiment of a tenth aspect of this disclosure;

FIG. 13 is a schematic diagram of an apparatus for receiving channel state information of an embodiment of an eleventh aspect of this disclosure;

FIG. 14 is a schematic diagram of an apparatus for receiving channel state information of an embodiment of a twelfth aspect of this disclosure;

FIG. 15 is a schematic diagram of a terminal equipment of an embodiment of a thirteenth aspect of this disclosure; and

FIG. 16 is a schematic diagram of a network device of the embodiment of the thirteenth aspect of this disclosure.

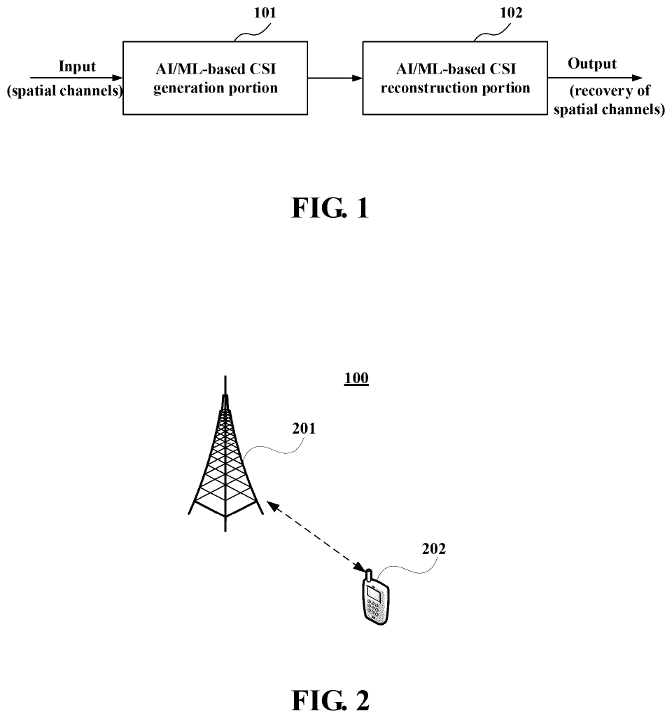

### DETAILED DESCRIPTION OF THE DISCLOSURE

These and further aspects and features of this disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the spirit and terms of the appended claims.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, the term “communication network” or “wireless communication network” may refer to a network satisfying any one of the following communication standards: long term evolution (LTE), long term evolution-advanced (LTE-A), wideband code division multiple access (WCDMA), and high-speed packet access (HSPA), etc.

And communication between devices in a communication system may be performed according to communication protocols at any stage, which may, for example, include but not limited to the following communication protocols: 1G (generation), 2G, 2.5G, 2.75G, 3G, 4G, 4.5G, 5G, and new radio (NR), etc., and/or other communication protocols that are currently known or will be developed in the future.

In the embodiments of this disclosure, the term “network device”, for example, refers to a device in a communication system that accesses a user equipment to the communication network and provides services for the user equipment. The network device may include but not limited to the following devices: a node and/or donor in an IAB architecture, a base station (BS), an access point (AP), a transmission reception point (TRP), a broadcast transmitter, a mobile management entity (MME), a gateway, a server, a radio network controller (RNC), a base station controller (BSC), etc.

The base station may include but not limited to a node B (NodeB or NB), an evolved node B (eNodeB or eNB), and a 5G base station (gNB), etc. Furthermore, it may include a remote radio head (RRH), a remote radio unit (RRU), a relay, or a low-power node (such as a femto, and a pico, etc.). The term “base station” may include some or all of its functions, and each base station may provide communication coverage for a specific geographical area. And a term “cell” may refer to a base station and/or its coverage area, depending on a context of the term.

In the embodiments of this disclosure, the term “user equipment (UE)” or “terminal equipment (TE) or terminal device” refers to, for example, an equipment accessing to a communication network and receiving network services via a network device. The user equipment may be fixed or mobile, and may also be referred to as a mobile station (MS), a terminal, a subscriber station (SS), an access terminal (AT), or a station, etc.

The terminal equipment may include but not limited to the following devices: a cellular phone, a personal digital assistant (PDA), a wireless modem, a wireless communication device, a hand-held device, a machine-type communication device, a lap-top, a cordless telephone, a smart cell phone, a smart watch, and a digital camera, etc.

For another example, in a scenario of the Internet of Things (IoT), etc., the terminal equipment may also be a machine or a device performing monitoring or measurement. For example, it may include but not limited to a machine-type communication (MTC) terminal, a vehicle mounted communication terminal, an industrial wireless device, a surveillance camera, a device to device (D2D) terminal, and a machine to machine (M2M) terminal, etc.

Moreover, the term “network side” or “network device side” refers to a side of a network, which may be a base station or one or more network devices including those described above. The term “user side” or “terminal side” or “terminal equipment side” refers to a side of a user or a terminal, which may be a UE, and may include one or more terminal equipments described above.

In the following description, without causing confusion, the terms “uplink control signal” and “uplink control information (UCI)” or “physical uplink control channel (PUCCH)” are interchangeable, and terms “uplink data signal” and “uplink data information” or “physical uplink shared channel (PUSCH)” are interchangeable.

The terms “downlink control signal” and “downlink control information (DCI)” or “physical downlink control channel (PDCCH)” are interchangeable, and the terms “downlink data signal” and “downlink data information” or “physical downlink shared channel (PDSCH)” are interchangeable.

In addition, transmitting or receiving a PUSCH may be understood as transmitting or receiving uplink data carried by the PUSCH, transmitting or receiving a PUCCH may be understood as transmitting or receiving uplink information carried by the PUCCH, transmitting or receiving a PRACH may be understood as transmitting or receiving a preamble carried by the PRACH. The uplink signal may include an uplink data signal and/or an uplink control signal, etc., and may be referred to as uplink transmission or uplink information or an uplink channel. Transmitting uplink transmission on an uplink resource may be understood as transmitting the uplink transmission by using the uplink resource. Likewise, downlink data/signal/channel/information may be understood correspondingly.

In the embodiments of this disclosure, higher-layer signaling may be, for example, radio resource control (RRC) signaling; for example, it is referred to an RRC message, which includes an MIB, system information, and a dedicated RRC message; or, it is referred to an as an RRC information element (RRC IE). Higher-layer signaling may also be, for example, medium access control (MAC) signaling, or an MAC control element (MAC CE); however, this disclosure is not limited thereto.

Scenarios in the embodiments of this disclosure shall be described below by way of examples; however, this disclosure is not limited thereto.

FIG. 2 is a schematic diagram of a communication system of this disclosure, in which a case where a terminal equipment and a network device are taken as examples is schematically shown. As shown in FIG. 2, the communication system 100 may include a network device 201 and a terminal equipment 202 (for the sake of simplicity, an example having only one terminal equipment is schematically given in FIG. 2).

In the embodiments of this disclosure, existing traffics or traffics that may be implemented in the future may be performed between the network device 201 and the terminal equipment 202. For example, such traffics may include but not limited to enhanced mobile broadband (eMBB), massive machine type communication (MTC), and ultra-reliable and low-latency communication (URLLC), etc.

The terminal equipment 202 may transmit data to the network device 201, such as in a grant or grant-free manner. The network device 201 may receive data transmitted by one or more terminal equipments 202, and feed back information to the terminal equipment 202, such as acknowledgement (ACK)/non-acknowledgement (NACK) information, and the terminal equipment 202 may acknowledge to terminate a transmission process, or may perform transmission of new data, or may perform data retransmission.

In the following description of this disclosure, an artificial intelligence (AI) model may also be referred to as an artificial intelligence/machine learning (AI/ML) model, and the two terms are interchangeable.

In the following embodiments of this disclosure, signaling transmitted by a network device to a terminal equipment may be transmitted via downlink control information (DCI), a media access control control element (MAC CE), and/or radio resource control (RRC) signaling.

In the following embodiments of this disclosure, there exists a pairing relationship between an AI/ML-based CSI generation portion and an AI/ML-based CSI reconstruction portion, the former being applicable to a terminal equipment side, and the latter being applicable to a network device side. If the terminal equipment uses an AI/ML-based CSI generation portion, the network device must use an AI/ML-based CSI reconstruction portion paired with the AI/ML-based CSI generation portion to successfully reconstruct channel information. If the network device uses an AI/ML-based CSI reconstruction portion, the terminal equipment must use an AI/ML-based CSI generation portion paired with the AI/ML-based CSI reconstruction portion to successfully reconstruct channel information at the network device side.

The AI/ML-based CSI generation portion includes an AI/ML model, which may be used to generate more than one of precoding matrix information, a rank indicator (RI), a layer indicator (LI), a channel resource indicator (CRI) and a channel quality indicator (CQI). In addition, the RI, LI, CRI and CQI may not be generated by the AI/ML model. For example, the AI/ML-based CSI generation portion may further include more than one of a module for generating an RI, a module for generating an LI, a module for generating a CRI, and a module for generating a CQI. The AI/ML-based CSI generation portion may further include other modules, such as a module for truncating a bit sequence.

The information of the AI/ML-based CSI generation portion may be composed of AI/ML model information and/or information of a module for generating an RI and/or information of a module for generating an LI and/or information of a module for generating a CRI and/or information of a module for generating a CQI and/or information of a module for truncating a bit sequence and/or information of modules for implementing other functions (if any).

The AI/ML model may include three parts, a preprocessing module, an AI/ML encoder and a quantizer. Hence, the AI/ML model information may include preprocessing module information, AI/ML encoder information, and quantizer information. For example, a piece of AI/ML model information may be described by using “preprocessing module #2,AI/ML encoder #4,quantizer #A”. In addition, the preprocessing module, AI/ML encoder and quantizer may also be regarded as a whole to annotate the AI/ML model information, that is, AI/ML model information may also be denoted as, for example, AI/ML model information #4,etc.

The AI/ML reconstruction model of the AI/ML-based CSI reconstruction portion paired with the AI/ML model in the AI/ML-based CSI generation portion may also include three parts, a de-quantizer, an AI/ML decoder and a post-processing module. Hence, the AI/ML reconstruction model information may include de-quantizer information, AI/ML decoder information and post-processing module information. For example, a piece of AI/ML reconstruction model information may be described by “de-quantizer #B, AI/ML decoder #1, post-processing module #2”. In addition, the AI/ML reconstruction model information may also be expressed as, for example, AI/ML reconstruction model #1, or may be simply referred to as AI/ML model #1, so as to express a pairing relationship between it and AI/ML model #1 in the AI/ML-based CSI generation portion.

The AI/ML model may also be composed of two parts (for example, it does not include the preprocessing module, or the preprocessing module is included in the AI/ML encoder, and is regarded as a whole with the AI/ML encoder), that is, the AI/ML model includes an AI/ML encoder and a quantizer. At this time, the AI/ML model information may be composed of AI/ML encoder information and quantizer information. The AI/ML reconstruction model of the AI/ML-based CSI reconstruction portion paired with the AI/ML model may also also be composed of two parts, a de-quantizer and an AI/ML decoder. At this time, the AI/ML reconstruction model information is composed of de-quantizer information and AI/ML decoder information. The preprocessing module may be contained in the AI/ML encoder, or may not be included in the AI/ML encoder. The post-processing module may be contained in the AI/ML decoder, or may not be included in the AI/ML decoder.

The AI/ML model may also be composed of one part, that is, the AI/ML encoder and the quantizer are regarded as a whole (for example, the AI/ML encoder and the quantizer are inseparable and cannot be freely combined), and the AI/ML encoder may or may not include a preprocessing module. At this time, the AI/ML model information is only composed of one part, for example, the AI/ML model information is AI/ML model #5. The AI/ML reconstruction model may also be composed of one part, that is, the de-quantizer and the AI/ML decoder are regarded as a whole (for example, the AI/ML decoder and the de-quantizer are inseparable and cannot be freely combined), and the AI/ML decoder may or may not include a post-processing module. At this time, the AI/ML reconstruction model information is only composed of one part. For example, the AI/ML reconstruction model information is AI/ML reconstruction model #5, or is simply referred to as AI/ML model #5, so as to express a pairing relationship between it and AI/ML model #5 in the AI/ML-based CSI generation portion.

In the embodiments of this disclosure, report may refer to an action of transmitting information by a terminal equipment to a network device. For example, reporting CSI by the equipment may refer to transmitting the CSI by the terminal equipment to the network device.

### Embodiments of a First Aspect

The embodiments of the first aspect provides a method for transmitting channel state information (CSI), applicable to a terminal equipment, such as the terminal equipment 202 in FIG. 2.

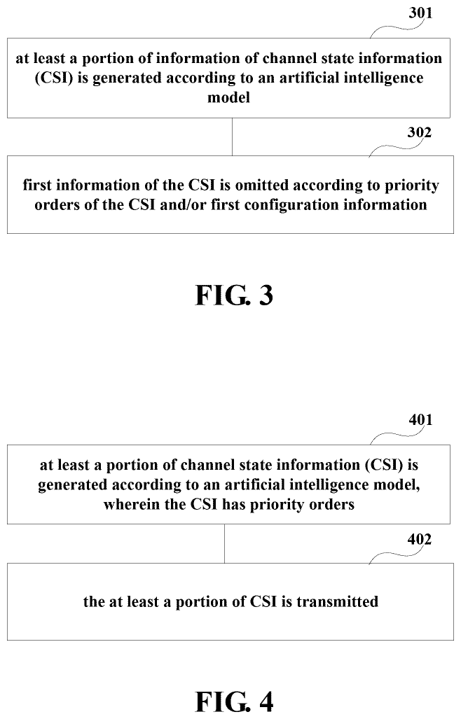

FIG. 3 is a schematic diagram of the method for transmitting channel state information (CSI) of the first aspect of this disclosure. As shown in FIG. 3, the method includes:
operation 301: at least a portion of information of channel state information (CSI) is generated according to an artificial intelligence model; and
operation 302: first information of the CSI is omitted according to priority orders of the CSI and/or first configuration information.

In at least one embodiment, the terminal equipment may execute operation 302 for such cases as occurrence of CSI conflicts, limited uplink resources, or conservation of uplink resources, etc., wherein the uplink resources include physical uplink shared channels (PUSCHs) and/or physical uplink control channels (PUCCHs), etc. For example, the omitting the first information of the CSI in operation 302 may occur in CSI report carried by a physical uplink shared channel (PUSCH) and/or CSI report carried by a physical uplink control channel (PUCCH).

With the embodiments of the first aspect, the terminal equipment may omit the CSI generated based on the AI/ML model, thereby avoiding possible ambiguities that may arise when the network device reads the CSI.

In at least one embodiment, in operation 301, at least a portion of the CSI generated by the terminal equipment includes two parts, a first part (part 1) and a second part (part 2), wherein the first part of the CSI includes a rank indicator (RI) and/or at least a portion of a channel quality indicator (CQI) and/or a channel state information reference signal resource indicator (CRI), and the second part of the CSI includes information on a precoding matrix and/or at least a portion of a channel quality indicator (CQI) and/or a layer indicator (LI), wherein at least the information on the precoding matrix is generated based on the artificial intelligence model. However, this disclosure is not limited thereto, and other information in the CSI may also be generated based on the artificial intelligence model. For example, at least a portion of the channel quality indicator (CQI) and/or the layer indicator (LI) in the second part of the CSI may be generated based on the artificial intelligence model.

The first information of the CSI omitted in operation 302 may be at least a portion of information in the second part of the CSI, such as a portion of part 2 information of the CSI omitted in operation 302, or all information of part 2 of CSI omitted in operation 302. When the terminal equipment omits all the information of part 2 of the CSI, the network device may take an identity matrix as a precoding matrix used in downlink transmission.

In at least one embodiments of operation 302, the terminal equipment may omit the first information of the CSI according to the priority orders of the CSI. For example, the first information of the CSI may be omitted in a priority order from low to high, wherein information with lower priority orders (e.g. numbers to which the priority orders correspond are smaller) is omitted first, and information with higher priority orders (e.g. numbers to which the priority orders correspond are larger) is omitted later.

In at least one piece of CSI report, the priority orders of the CSI may be set according to information on a layer of part 2 and/or information on predetermined bits in the layer. For example, the priority orders are set according only to the information on a layer, or, the priority orders are set according to the information on a layer and the information on predetermined bits, or, the priority orders are set according only to the information on predetermined bits. For example, in a case where the CSI has only one layer, the priority orders are set according only to the information on predetermined bits.

In at least one embodiment, mapping relationships may be formed between the priority orders and the information a layer and/or the information on predetermined bits in the layer, and there may be one or at least two groups of mapping relationships. The priority orders of the CSI may be determined according to the mapping relationships.

In the case where there are at least two groups of mapping relationships, the priority orders of the CSI may be set based on one of the at least two groups of mapping relationships. The group of mapping relationships may be preset, or may be selected by the terminal equipment (e.g. terminal equipment 202), or may be configured by the network device (e.g. network device 201), wherein in the case where the group of mapping relationships is selected by the terminal equipment, the terminal equipment may receive information transmitted by the network device, the information instructing the terminal equipment to transmit information on the group of mapping relationships to the network device, and the terminal equipment may transmit the information on the group of mapping relationships to the network device according to the information. Hence, the network device may learn a mode for setting the priority orders of the CSI. The information on the group of mapping relationships may include such information as indices of the group of mapping relationships, etc.

In at least one embodiment, in CSI report, part 2 has one layer or at least two layers. In the case where part 2 has at least two layers, each layer may be generated based on identical artificial intelligence models, or the at least two layers are generated based on different artificial intelligence models.

In at least one embodiment, the information on a layer includes an order of the layer, wherein the order of the layer may be set according to an arrangement order of an eigenvalue or singular value of a spatial channel matrix to which the layer corresponds. For example, the larger the eigenvalue or singular value to which the layer corresponds, the higher the order of the layer, and the higher the priority order of the CSI to which the layer corresponds, that is, the more backward the CSI of the layer, the more possible it is omitted.

In at least one embodiment, the information on predetermined bits may include a proportion of the predetermined bits in a bit sequence to which the layer corresponds.

In the case where part 2 of the CSI report has at least two layers, for different layers, the proportion is equal; or, for the at least two layers, the proportion is not equal.

The number of the predetermined bits, i.e. the number of bits, may be determined according to the proportion. For example, a total number of bits in the bit sequence to which the layer corresponds may be multiplied by this proportion, and the obtained result is rounded up (such as rounding up, rounding down, rounding off), and the resulting number is the number of the bits.

In at least another embodiment, the information on predetermined bits may include the number of the predetermined bits, that is, the proportion is replaced by the number of the predetermined bits. Thus, the number of the predetermined bits may be determined more directly.

In the case where part 2 of the CSI report has at least two layers, for different layers, the numbers of the predetermined bits are identical; or, for the at least two layers, the numbers of the predetermined bits are different.

In at least one further embodiment, the information on predetermined bits further includes positions of the predetermined bits in the bit sequence to which the layer corresponds. For example, a certain number or proportion of the predetermined bits are located at front, or back, or odd or even positions of the bit sequence.

In at least one embodiments of this disclosure, the information on predetermined bits may be preset information, or, the information on predetermined bits is configured by the network device, or, the information on predetermined bits is determined by the terminal equipment, and the terminal equipment further reports the information on predetermined bits to the network device.

It should be noted that in tables and words of this application, “a priority order N (N is a non-negative integer, for example, N is 1, 2, and 3, etc.)” may be referred to as a priority level N, or may be referred to as “a priority order level N”, or may be referred to as “a priority reporting level N”, or may be referred to as “a priority order value N”, etc.

A specific mode for omitting the first information of the CSI according to the priority order of the CSI in operation 302 shall be described below by way of several examples.

In the following examples, it is assumed that there total M (M is a natural number) pieces of CSI report, meanings of priorities of the M pieces of CSI report being different from a meaning of the priority order of the CSI. The priorities of the CSI report may be determined based on relevant techniques. In the following examples, it is assumed that the CSI report has 4 layers respectively and M=3. In the CSI report, the priority order of part 2 of the CSI may be according to the information on a layer and regulations, as shown in tables 1˜4 below.

Tables 1˜4 are two examples of the priority order of the CSI. In Tables 1 and 2, the order of layers is arranged in a descending order of eigenvalues or singular values of the spatial channel matrix, wherein a rank of the spatial channel matrix is equal to the number of matrix eigenvalues or singular values. The total number of the layers is identical to that of RIs, and an RI is less than or equal to the rank.

TABLE 1

| | #1 | #2 | #3 | #4 |
|---|---|---|---|---|
| Priority | A first layer (all) of | A first layer (all) of | A first layer (all) of | A first layer (all) of |
| order 1 | part 2 of the CSI in | part 2 of the CSI in | part 2 of the CSI in | part 2 of the CSI in |
| | CSI report 1 | CSI report 1 | CSI report 1 | CSI report 1 |
| Priority | A second layer (all) | A proportion of a | A second layer (all) | A second layer (all) |
| order 2 | of part 2 of the CSI | second layer of | of part 2 of the CSI | of part 2 of the CSI |
| | in CSI report 1 | part 2 of the CSI | in CSI report 1 | in CSI report 1 |
| | | in CSI report 1 | | |
| Priority | A third layer (all) | A proportion of a | A proportion of a | A third layer (all) |
| order 3 | of part 2 of the CSI | third layer of part | third layer of part | of part 2 of the CSI |
| | in CSI report 1 | 2 of the CSI in | 2 of the CSI in | in CSI report 1 |
| | | CSI report 1 | CSI report 1 | |
| Priority | A fourth layer (all) | Rest bits of a | A proportion of bits | A proportion of bits |
| order 4 | of part 2 of the CSI | second layer of | of a fourth layer of | of a fourth layer of |
| | in CSI report 1 | part 2 of the CSI | part 2 of the CSI in | part 2 of the CSI in |
| | | in CSI report 1 | CSI report 1 | CSI report 1 |
| Priority | A first layer (all) of | A proportion of bits | Rest bits of a third | Rest bits of a fourth |
| order 5 | part 2 of the CSI in | of a fourth layer of | layer of part 2 of | layer of part 2 |
| | CSI report 2 | part 2 of the CSI in | the CSI in CSI | of the CSI in |
| | | CSI report 1 | report 1 | CSI report 1 |
| Priority | A second layer (all) | Rest bits of a third | Rest bits of a fourth | A first layer (all) |
| order 6 | of part 2 of the CSI | layer of part 2 | layer of part 2 | of part 2 of the |
| | in CSI report 2 | of the CSI in | of the CSI in | CSI in CSI |
| | | CSI report 1 | CSI report 1 | report 2 |
| Priority | A third layer (all) | Rest bits of a fourth | A first layer (all) | A second layer (all) |
| order 7 | of part 2 of the CSI | layer of part 2 | of part 2 of the | of part 2 of the CSI |
| | in CSI report 2 | of the CSI in | CSI in CSI report | in CSI report 2 |
| | | CSI report 1 | 2 | |
| Priority | A fourth layer (all) | A first layer (all) of | A second layer (all) | A third layer (all) |
| order 8 | of part 2 of the CSI | part 2 of the CSI in | of part 2 of the CSI | of part 2 of the CSI |
| | in CSI report 2 | CSI report 2 | in CSI report 2 | in CSI report 2 |
| Priority | A first layer (all) of | A proportion of bits | A proportion of bits | A proportion of bits |
| order 9 | part 2 of the CSI in | of a second layer of | of a third layer of | of a fourth layer of |
| | CSI report 3 | part 2 of the CSI in | part 2 of the CSI in | part 2 of the CSI in |
| | | CSI report 2 | CSI report 2 | CSI report 2 |
| Priority | A second layer (all) | A proportion of bits | A proportion of | Rest bits of a fourth |
| order 10 | of part 2 of the CSI | of a third layer of | of a fourth layer of | layer of part 2 |
| | in CSI report 3 | part 2 of the CSI in | part 2 of the CSI in | of the CSI in |
| | | CSI report 2 | CSI report 2 | CSI report 2 |
| Priority | A third layer (all) | Rest bits of a | Rest bits of a third | A first layer (all) of |
| order 11 | of part 2 of the CSI | second layer of | layer of part 2 of | part 2 of the CSI in |
| | in CSI report 3 | part 2 of the CSI | the CSI in CSI | CSI report 3 |
| | | in CSI report 2 | report 2 | |
| Priority | A fourth layer (all) | A proportion of bits | Rest bits of a fourth | A second layer (all) |
| order 12 | of part 2 of the CSI | of a fourth layer of | layer of part 2 | of part 2 of the CSI |
| | in CSI report 3 | part 2 of the CSI in | of the CSI in | CSI report 3 |
| | | CSI report 2 | CSI report 2 | |
| Priority | None | Rest bits of a | A first layer (all) of | A third layer (all) |
| order 13 | | third layer of | part 2 of the CSI in | of part 2 of the |
| | | part 2 of the CSI | CSI report 3 | CSI in CSI |
| | | in CSI report 2 | | report 3 |
| Priority | None | Rest bits of a | A second layer (all) | A proportion of bits |
| order 14 | | fourth layer of | of part 2 of the CSI | of a fourth layer of |
| | | part 2 of the CSI | in CSI report 3 | part 2 of the CSI in |
| | | in CSI report 2 | | CSI report 3 |
| Priority | None | A first layer (all) of | A proportion of bits | Rest bits of a |
| order 15 | | part 2 of the CSI in | of a third layer of | fourth layer of |
| | | CSI report 3 | part 2 of the CSI in | part 2 of the CSI |
| | | | CSI report 3 | in CSI report 3 |
| Priority | None | A proportion of bits | A proportion of bits | None |
| order 16 | | of a second layer of | of a fourth layer of | |
| | | part 2 of the CSI in | part 2 of the CSI in | |
| | | CSI report 3 | CSI report 3 | |
| Priority | None | A proportion of bits | Rest bits of a third | None |
| order 17 | | of a third layer of | layer of part 2 of | |
| | | part 2 of the CSI in | the CSI in CSI | |
| | | CSI report 3 | report 3 | |
| Priority | None | Rest bits of a | Rest bits of a | None |
| order 18 | | second layer of | fourth layer of | |
| | | part 2 of the CSI | part 2 of the CSI | |
| | | in CSI report 3 | in CSI report 3 | |
| Priority | None | A proportion of bits | None | None |
| order 19 | | of a fourth layer of | | |
| | | part 2 of the CSI in | | |
| | | CSI report 3 | | |
| Priority | None | Rest bits of a | None | None |
| order 20 | | third layer of | | |
| | | part 2 of the CSI | | |
| | | in CSI report 3 | | |
| Priority | None | Rest bits of a | None | None |
| order 21 | | fourth layer of | | |
| | | part 2 of the CSI | | |
| | | in CSI report 3 | | |

In Table 1, the terminal equipment may omit the first information of the CSI in a descending order of values of the priority orders.

In Table 1, #1˜ #4 denote different mapping relationships. In the mapping relationship shown in #1, the priority order of the CSI is set based on the information on a layer. In the mapping relationships shown in #2, #3 and #4, the priority order of the CSI is set based on the information on a layer and the information on predetermined bits in the layer, wherein the information on predetermined bits includes a proportion of the predetermined bits.

In Table 1, for the mapping relationship shown in #2, “a certain proportion of bits” may be identical for all priority orders, or, proportions of at least two priority orders are different.

10 In Table 1, for the mapping relationship shown in #3, “a certain proportion of bits” may be identical for all priority orders, or, proportions of at least two priority orders are different.

In Table 1, for the mapping relationship shown in #4, “a certain proportion of bits” may be identical for all priority orders, or, proportions of at least two priority orders are different.

In Table 1, the method for calculating the number of bits based on a “a certain proportion of bits” may be predetermined, or may be configured by the network device. For example, the number of bits in the bit sequence to which the layer corresponds may be multiplied by the proportion, and the result is rounded in a certain manner, such as rounding up, rounding down, and rounding off, etc.

In Table 1, “a certain proportion of bits” and/or positions of the certain proportion of bits in the bit sequence may be predetermined, or may be configured by the network device, or may be determined by the terminal equipment. For example, the certain proportion of bits and their positions may correspond to: former K bits in the bit sequence, or, latter K bits in the bit sequence, or, K bits, wherein priority orders of odd bits are lower than those of even bits, or, K bits, wherein priority orders of even bits are lower than those of odd bits; however, it is not limited thereto. In the case where it is/they are configured by the network device, the network device may transmit index 1 to the terminal equipment, index 1 being used to indicate the certain proportion of bits and/or positions of the certain proportion of bits in the bit sequence. For the case where it is/they are configured by the terminal equipment, the terminal equipment may report index 2 to the network device, index 2 being used to indicate such information as the certain proportion of bits and/or positions of the certain proportion of bits in the bit sequence determined by the terminal equipment, etc. Positions of index 1 and index 2 in a feedback bit sequence may be specified in standards or agreed upon in advance by the network device and the terminal equipment.

In some implementations, the priority order of the CSI may only have one specification, such as a mapping relationship to which a column in Table 1 corresponds. The terminal equipment may omit the first information in the CSI according to the priority order of the CSI.

In some implementations, the priority order of the CSI may have at least two specifications, such as mapping relationships to which at least two columns in Table 1 correspond. According to configuration of the network device, the terminal equipment may determine which group of mapping relationships is used to set the priority order of the CSI and omit the CSI; or, the terminal equipment may determine by itself which group of mapping relationships is used to set the priority order of the CSI, omit the CSI, and feed back indices of the group of mapping relationships to the network device. Positions of the indices of the mapping relationships in the feedback bit sequence may be provided in standards or agreed upon in advance by the network device and the terminal equipment.

In the examples shown in tables 2 and 3, it is assumed that M=3 and there are 3 pieces of CSI report. As marked in tables 2 and 3, the number of bits of part 2 of the CSI of priority order k is marked as nₖ, then aₖ≤nₖ, by <nₖ, Ck≤nₖ and k=1, 2, . . . 12. nₖ, k=1,2,3,4, which may be equal, or more than two nₖs are not equal.nₖ>k=5,6,7,8, which may be equal, or more than two nₖs are not equal.nₖ, k=9,10,11,12, which may be equal, or more than two nks are not equal. The 12 aₖs may be equal, or more than two aₖs are not equal. The 12 bₖs may be equal, or more than two bₖs are not equal. The 12 cₖs may be equal, or more than two cₖs are not equal.

TABLE 2

| | #1 | #2 | #3 |
|---|---|---|---|
| Priority | a₁ bits of a first layer of | b₁ bits of the first layer of | c₁ bits of the first layer of |
| order 1 | part 2 of the CSI in CSI | part 2 of the CSI in CSI | part 2 of the CSI in CSI |
| | report 1 | report 1 | report 1 |
| Priority | Rest bits of the first layer of | b2 bits of a second layer | Rest bits of the first layer of |
| order 2 | part 2 of the CSI in CSI report | of part 2 of the CSI in | part 2 of the CSI in CSI report |
| | 1 (the rest bits may not exist, | CSI report 1 | 1 (the rest bits may not exist, |
| | and at this time, the priority | | and at this time, the priority |
| | order does not exist) | | order does not exist) |
| Priority | a₂ bits of a second layer | Rest bits of the first layer of | c₂ bits of the second layer |
| order 3 | of part 2 of the CSI in | part 2 of the CSI in CSI report | of part 2 of the CSI in CSI |
| | CSI report 1 | 1 (the rest bits may not exist, | report 1 |
| | | and at this time, the priority | |
| | | order does not exist) | |
| Priority | a₃ bits of the second layer | b₃ bits of the second layer | c₃ bits of the second layer |
| order 4 | of part 2 of the CSI in | of part 2 of the CSI in | of part 2 of the CSI in CSI |
| | CSI report 1 | CSI report 1 | report 1 |
| Priority | Rest bits of the second layer | Rest bits of the second layer | Rest bits of the second layer |
| order 5 | of part 2 of the CSI in CSI | of part 2 of the CSI in CSI | of part 2 of the CSI in CSI |
| | report 1 (the rest bits may not | report 1 (the rest bits may not | report 1 (the rest bits may not |
| | exist, and at this time, the | exist, and at this time, the | exist, and at this time, the |
| | priority order does not exist) | priority order does not exist) | priority order does not exist) |
| Priority | a₄ bits of a fourth layer of | b₄ bits of the fourth layer | Rest bits of a third layer of |
| order 6 | part 2 of the CSI in CSI | of part 2 of the CSI in | part 2 of the CSI in CSI report |
| | report 1 | CSI report 1 | 1 (the rest bits may not exist, |
| | | | and at this time, the priority |
| | | | order does not exist) |
| Priority | Rest bits of a third layer of | Rest bits of a third layer of | c₄ bits of the fourth layer of |
| order 7 | part 2 of the CSI in CSI report | part 2 of the CSI in CSI report | part 2 of the CSI in CSI |
| | 1 (the rest bits may not exist, | 1 (the rest bits may not exist, | report 1 |
| | and at this time, the priority | and at this time, the priority | |
| | order does not exist) | order does not exist) | |
| Priority | Rest bits of the fourth layer of | Rest bits of the fourth layer of | Rest bits of the fourth layer of |
| order 8 | part 2 of the CSI in CSI report | part 2 of the CSI in CSI report | part 2 of the CSI in CSI report |
| | 1 (the rest bits may not exist, | 1 (the rest bits may not exist, | 1 (the rest bits may not exist, |
| | and at this time, the priority | and at this time, the priority | and at this time, the priority |
| | order does not exist) | order does not exist) | order does not exist) |
| Priority | a₅ bits of a first layer of part | b₅ bits of the first layer of part | c₅ bits of the first layer of part |
| order 9 | 2 of the CSI in CSI report 2 | 2 of the CSI in CSI report 2 | 2 of the CSI in CSI report 2 |
| Priority | Rest bits of the first layer of | b₆ bits of a second layer | Rest bits of the first layer of |
| order 10 | part 2 of the CSI in CSI report | of part 2 of the CSI in | part 2 of the CSI in CSI report |
| | 2 (the rest bits may not exist, | CSI report 2 | 2 (the rest bits may not exist, |
| | and at this time, the priority | | and at this time, the priority |
| | order does not exist) | | order does not exist) |
| Priority | a₆ bits of the second | Rest bits of the first layer of | c₆ bits of the second layer |
| order 11 | layer of part 2 of the CSI | part 2 of the CSI in CSI report | of part 2 of the CSI in CSI |
| | in CSI report 2 | 2 (the rest bits may not exist, | report 2 |
| | | and at this time, the priority | |
| | | order does not exist) | |
| Priority | a₇ bits of a third layer of | b₇ bits of the third layer | c₇ bits of the third layer |
| order 12 | part 2 of the CSI in CSI | of part 2 of the CSI in | of part 2 of the CSI in |
| | report 2 | CSI report 2 | CSI report 2 |
| Priority | Rest bits of the second layer | Rest bits of the second layer | Rest bits of the second layer |
| order 13 | of part 2 of the CSI in CSI | of part 2 of the CSI in CSI | of part 2 of the CSI in CSI |
| | report 2 (the rest bits may not | report 2 (the rest bits may not | report 2 (the rest bits may not |
| | exist, and at this time, the | exist, and at this time, the | exist, and at this time, the |
| | priority order does not exist) | priority order does not exist) | priority order does not exist) |
| Priority | a₈ bits of the fourth | b₈ bits of the fourth | Rest bits of the third layer of |
| order 14 | layer of part 2 of the CSI | layer of part 2 of the CSI | part 2 of the CSI in CSI report |
| | in CSI report 2 | in CSI report 2 | 2 (the rest bits may not exist, |
| | | | and at this time, the priority |
| | | | order does not exist) |
| Priority | Rest bits of the third layer of | Rest bits of the third layer of | c₈ bits of the fourth layer |
| order 15 | part 2 of the CSI in CSI report | part 2 of the CSI in CSI report | of part 2 of the CSI in CSI |
| | 2 (the rest bits may not exist, | 2 (the rest bits may not exist, | report 2 |
| | and at this time, the priority | and at this time, the priority | |
| | order does not exist) | order does not exist) | |
| Priority | Rest bits of the fourth layer of | Rest bits of the fourth layer of | Rest bits of the fourth layer of |
| order 16 | part 2 of the CSI in CSI report | part 2 of the CSI in CSI report | part 2 of the CSI in CSI report |
| | 2 (the rest bits may not exist, | 2 (the rest bits may not exist, | 2 (the rest bits may not exist, |
| | and at this time, the priority | and at this time, the priority | and at this time, the priority |
| | order does not exist) | order does not exist) | order does not exist) |
| Priority | a₉ bits of a first layer of part | b₉ bits of the first layer of part | c₉ bits of the first layer of part |
| order 17 | 2 of the CSI in CSI report 3 | 2 of the CSI in CSI report 3 | 2 of the CSI in CSI report 3 |
| Priority | Rest bits of the first layer of | b₁₀ bits of the second | Rest bits of the first layer of |
| order 18 | part 2 of the CSI in CSI report | layer of part 2 of the CSI | part 2 of the CSI in CSI report |
| | 3 (the rest bits may not exist, | in CSI report 3 | 3 (the rest bits may not exist, |
| | and at this time, the priority | | and at this time, the priority |
| | order does not exist) | | order does not exist) |
| Priority | a₁₀ bits of the second | Rest bits of the first layer of | c₁₀ bits of the second layer |
| order 19 | layer of part 2 of the CSI | part 2 of the CSI in CSI report | of part 2 of the CSI in CSI |
| | in CSI report 3 | 3 (the rest bits may not exist, | report 3 |
| | | and at this time, the priority | |
| | | order does not exist) | |
| Priority | a₁₁ bits of a third layer | b₁₁ bits of the third layer | c₁₁ bits of the third layer |
| order 20 | of part 2 of the CSI in | of part 2 of the CSI in | of part 2 of the CSI in CSI |
| | CSI report 3 | CSI report 3 | report 3 |
| Priority | Rest bits of the second layer | Rest bits of the second layer | Rest bits of the second layer |
| order 21 | of part 2 of the CSI in CSI | of part 2 of the CSI in CSI | of part 2 of the CSI in CSI |
| | report 3 (the rest bits may not | report 3 (the rest bits may not | report 3 (the rest bits may not |
| | exist, and at this time, the | exist, and at this time, the | exist, and at this time, the |
| | priority order does not exist) | priority order does not exist) | priority order does not exist) |
| Priority | a₁₂ bits of a fourth layer | b₁₂ bits of the fourth | Rest bits of the third layer of |
| order 22 | of part 2 of the CSI in | layer of part 2 of the CSI | part 2 of the CSI in CSI report |
| | CSI report 3 | in CSI report 3 | 3 (the rest bits may not exist, |
| | | | and at this time, the priority |
| | | | order does not exist) |
| Priority | Rest bits of the third layer of | Rest bits of the third layer of | c₁₂ bits of the fourth layer |
| order 23 | part 2 of the CSI in CSI report | part 2 of the CSI in CSI report | of part 2 of the CSI in CSI |
| | 3 (the rest bits may not exist, | 3 (the rest bits may not exist, | report 3 |
| | and at this time, the priority | and at this time, the priority | |
| | order does not exist) | order does not exist) | |
| Priority | Rest bits of the fourth layer of | Rest bits of the fourth layer of | Rest bits of the fourth layer of |
| order 24 | part 2 of the CSI in CSI report | part 2 of the CSI in CSI report | part 2 of the CSI in CSI report |
| | 3 (the rest bits may not exist, | 3 (the rest bits may not exist, | 3 (the rest bits may not exist, |
| | and at this time, the priority | and at this time, the priority | and at this time, the priority |
| | order does not exist) | order does not exist) | order does not exist) |

TABLE 3

| | #1 | #2 | #3 |
|---|---|---|---|
| Priority | a₁, a₅ and a₉ bits of a first layer of | May be other | May be other |
| order 0 | part 2 of the CSI in CSI report 1-3 | combinations | combinations |
| Priority | Rest bits of the first layer of part 2 | | |
| order 1 | of the CSI in CSI report 1 (the rest | | |
| | bits may not exist, and at this time, | | |
| | the priority order does not exist) | | |
| Priority | a₂ bits of a second layer of part 2 of | | |
| order 2 | the CSI in CSI report 1 | | |
| Priority | a₃ bits of a third layer of part 2 of | | |
| order 3 | the CSI in CSI report 1 | | |
| Priority | Rest bits of the second layer of part | | |
| order 4 | 2 of the CSI in CSI report 1 (the rest | | |
| | bits may not exist, and at this time, | | |
| | the priority order does not exist) | | |
| Priority | a₄ bits of a fourth layer of part 2 of | | |
| order 5 | the CSI in CSI report 1 | | |
| Priority | Rest bits of the third layer of part 2 | | |
| order 6 | of the CSI in CSI report 1 (the rest | | |
| | bits may not exist, and at this time, | | |
| | the priority order does not exist) | | |
| Priority | Rest bits of the fourth layer of part 2 | | |
| order 7 | of the CSI in CSI report 1 (the rest | | |
| | bits may not exist, and at this time, | | |
| | the priority order does not exist) | | |
| Priority | Rest bits of a first layer of part 2 of | | |
| order 8 | the CSI in CSI report 2 (the rest bits | | |
| | may not exist, and at this time, the | | |
| | priority order does not exist) | | |
| Priority | a₆ bits of a second layer of part 2 of | | |
| order 9 | the CSI in CSI report 2 | | |
| Priority | a₇ bits of a third layer of part 2 of | | |
| order 10 | the CSI in CSI report 2 | | |
| Priority | Rest bits of a second layer of part 2 | | |
| order 11 | of the CSI in CSI report 2 (the rest | | |
| | bits may not exist, and at this time, | | |
| | the priority order does not exist) | | |
| Priority | a₈ bits of a fourth layer of part 2 of | | |
| order 12 | the CSI in CSI report 2 | | |
| Priority | Rest bits of a third layer of part 2 of | | |
| order 13 | the CSI in CSI report 2 (the rest bits | | |
| | may not exist, and at this time, the | | |
| | priority order does not exist) | | |
| Priority | Rest bits of a fourth layer of part 2 | | |
| order 14 | of the CSI in CSI report 2 (the rest | | |
| | bits may not exist, and at this time, | | |
| | the priority order does not exist) | | |
| Priority | Rest bits of a first layer of part 2 of | | |
| order 15 | the CSI in CSI report 3 (the rest bits | | |
| | may not exist, and at this time, the | | |
| | priority order does not exist) | | |
| Priority | a₁₀ bits of a second layer of part 2 of | | |
| order 16 | the CSI in CSI report 3 | | |
| Priority | a₁₁ bits of the third layer of part 2 of | | |
| order 17 | the CSI in CSI report 3 | | |
| Priority | Rest bits of the second layer of part | | |
| order 18 | 2 of the CSI in CSI report 3 (the rest | | |
| | bits may not exist, and at this time, | | |
| | the priority order does not exist) | | |
| Priority | a₁₂ bits of the fourth layer of part 2 | | |
| order 19 | of the CSI in CSI report 3 | | |
| Priority | Rest bits of the third layer of part 2 | | |
| order 20 | of the CSI in CSI report 3 (the rest | | |
| | bits may not exist, and at this time, | | |
| | the priority order does not exist) | | |
| Priority | Rest bits of the fourth layer of part 2 | | |
| order 21 | of the CSI in CSI report 3 (the rest | | |
| | bits may not exist, and at this time, | | |
| | the priority order does not exist) | | |

In table 2 or table 3, the terminal equipment may omit the first information of the CSI in a descending order of values of the priority orders.

In table 2 or table 3, #1˜ #3 denote different mapping relationships. In the mapping relationships shown in #1, #2 and #3, the priority order of the CSI is set according to the information on a layer and the information on predetermined bits in the layer, wherein the information on predetermined bits includes the number of predetermined bits, i.e. the number of bits, such as the numbers of bits aₖ, bₖ, and cₖ, etc., in table 2 or table 3. For the same priority order, aₖ, bₖ and bₖ may be identical, or at least two thereof are different.

In table 2 or table 3, the number of predetermined bits and/or the positions of the predetermined bits in the bit sequence may be predetermined, or may be configured by the network device, or may be determined by the terminal equipment. For example, the number of the predetermined bits and their positions may correspond to: former K bits in the bit sequence, or, latter K bits in the bit sequence, or, K bits, wherein priority orders of odd bits are lower than those of even bits, or, K bits, wherein priority orders of even bits are lower than those of odd bits; however, it is not limited thereto. In the case where they are configured by the network device, the network device may transmit index 3 to the terminal equipment, index 3 being used to indicate the number of predetermined bits and/or the positions of the predetermined bits in the bit sequence. For the case where they are determined by the terminal equipment, the terminal equipment may report index 4 to the network device, index 4 being used to indicate such information as the number of predetermined bits and/or the positions of the predetermined bits in the bit sequence determined by the terminal equipment, etc. Positions of index 3 and index 4 in a feedback bit sequence may be specified in standards or agreed upon in advance by the network device and the terminal equipment.

In some implementations, the priority order of the CSI may only have one specification, such as a mapping relationship to which a column in table 2 or table 3 corresponds. The terminal equipment may omit the first information in the CSI according to the priority order of the CSI.

In some implementations, the priority order of the CSI may have at least two specifications, such as mapping relationships to which at least two columns in table 2 or table 3 correspond. According to configuration of the network device, the terminal equipment may determine which group of mapping relationships is used to set the priority order of the CSI and omit the CSI; or, the terminal equipment may determine by itself which group of mapping relationships is used to set the priority order of the CSI, omit the CSI, and feed back indices of the group of mapping relationships to the network device. Positions of the indices of the mapping relationships in the feedback bit sequence may be provided in standards or agreed upon in advance by the network device and the terminal equipment.

In an example to which table 4 corresponds, it is assumed that M=3 and there are 3 pieces of CSI report. In the example to which table 4 corresponds, the CSI report has only one layer of downlink transmission, i.e. there is only one layer. As marked in table 4, the number of bits of part 2 of the CSI of priority order k is marked as mₖ, then xₖ≤mₖ, yₖ≤mₖ, zₖ≤mₖ and k=1,2,3,4. nₖ, k=1,2,3,4, which may be equal, or more than two nₖs are not equal. The 4 xₖS may be equal, or more than two xₖs are not equal. The 4 yₖs may be equal, or more than two yₖs are not equal. The 4 zₖs may be equal, or more than two zₖs are not equal.

TABLE 4

| | #1 | #2 | #3 |
|---|---|---|---|
| Priority | x₁ bits of part 2 | y₁ bits of part 2 | z₁ bits of part 2 |
| order 1 | of the CSI in | of the CSI in | of the CSI in |
| | CSI report 1 | CSI report 1 | CSI report 1 |
| Priority | x₂ bits of part 2 | y₂ bits of part 2 | z₂ bits of part 2 |
| order 2 | of the CSI in | of the CSI in | of the CSI in |
| | CSI report 2 | CSI report 2 | CSI report 2 |
| Priority | x₃ bits of part 2 | y₃ bits of part 2 | z₃ bits of part 2 |
| order 3 | of the CSI in | of the CSI in | of the CSI in |
| | CSI report 3 | CSI report 3 | CSI report 3 |
| Priority | x₄ bits of part 2 | y₄ bits of part 2 | z₄ bits of part 2 |
| order 4 | of the CSI in | of the CSI in | of the CSI in |
| | CSI report 4 | CSI report 4 | CSI report 4 |

In table 4, #1˜#3 denote different mapping relationships. As the example of table 4 has only one layer, in the mapping relationships shown in #1, #2 and #3, the priority order of the CSI is set according to the information on predetermined bits in the layer, wherein the information on predetermined bits includes the number of predetermined bits, i.e. the number of bits, such as the numbers of bits xₖ, yₖ, and zₖ, etc., in table 4. For the same priority order, xₖ, yₖ and zₖ may be identical, or at least two thereof are different.

In table 4, the number of predetermined bits and/or the positions of the predetermined bits in the bit sequence may be predetermined, or may be configured by the network device, or may be determined by the terminal equipment. For example, the number of the predetermined bits and their positions may correspond to: former K bits in the bit sequence, or, latter K bits in the bit sequence, or, K bits, wherein priority orders of odd bits are lower than those of even bits, or, K bits, wherein priority orders of even bits are lower than those of odd bits; however, it is not limited thereto. In the case where they are configured by the network device, the network device may transmit index 5 to the terminal equipment, index 5 being used to indicate the number of predetermined bits and/or the positions of the predetermined bits in the bit sequence. For the case where they are determined by the terminal equipment, the terminal equipment may report index 6 to the network device, index 6 being used to indicate such information as the number of predetermined bits and/or the positions of the predetermined bits in the bit sequence determined by the terminal equipment, etc. Positions of index 5 and index 6 in a feedback bit sequence may be specified in standards or agreed upon in advance by the network device and the terminal equipment.

In some implementations, the priority order of the CSI may only have one specification, such as a mapping relationship to which a column in table 4 corresponds. The terminal equipment may omit the first information in the CSI according to the priority order of the CSI.

In some implementations, the priority order of the CSI may have at least two specifications, such as mapping relationships to which at least two columns in table 4 correspond. According to configuration of the network device, the terminal equipment may determine which group of mapping relationships is used to set the priority order of the CSI and omit the CSI; or, the terminal equipment may determine by itself which group of mapping relationships is used to set the priority order of the CSI, omit the CSI, and feed back indices of the group of mapping relationships to the network device. Positions of the indices of the mapping relationships in the feedback bit sequence may be provided in standards or agreed upon in advance by the network device and the terminal equipment.

In some embodiments of operation 302, in the case where the terminal equipment omits the first information of the CSI according to the priority order of the CSI, the omitted first information may be all or a part of the CSI to which at least one priority reporting level in the priority order corresponds. “A priority reporting level N” may correspond to “a priority order N (N is a non-negative integer, for example, N is 1, 2, and 3, etc.)” in tables 1-4 or other tables, and may be referred to as a priority level N, or may be referred to as “a priority order level N”, or may be referred to as “a priority order value N”, etc.

In some examples, for a certain piece of CSI report, starting from a certain CSI priority reporting level in the used CSI priority order, if there are no enough uplink resources, the terminal equipment drops or omits information on CSI report to which the priority reporting level and a priority reporting level with a larger value correspond.

For example, for the case in table 1, there are four transport layers, and bitwidths of second information (for example, the second information refers to information output by AI/ML models used by the transport layers) of a first, second, third and fourth transport layers are 120 bits, 100 bits, 80 bits and 80 bits, respectively, that is, a sum of the bitwidths of the second information of all the layers is 380 bits. The CSI priority order given in column #2 of table 1 is used for the CSI report. For CSI report 3, numbers of “a certain proportion of bits” in the priority reporting levels 16, 17 and 19 of the CSI is a result obtained by multiplying the bitwidth of part 2 of the CSI in the transport layer in a value of the priority order respectively by 80%, 70% and 60% and rounding down. The uplink resources of the second information of all layers available for CSI report 3 are less than 380 bits, assuming that they are 340 bits, they are 40 bits less than the sum of the bitwidths of the second information of all layers. In this embodiment, there are 32 bits in CSI priority reporting level 21 and 24 bits in CSI priority reporting level 20. Even if there are 16 bits in the uplink resources (340 bits) available for transmitting bits in CSI priority order 20, according to the method in this example, all bits in CSI priority reporting level 20 and CSI priority reporting level 21 are omitted.

In addition, in this example, after receiving the CSI report from the terminal equipment, according to regulations in standards, the network device adds 24 “0” after a last bit of the received CSI of the third layer, and adds 32 “0” after adding bits to a last bit of the received CSI of the fourth layer. Hence, the network device recovers channel information.

In other examples, for a certain piece of CSI report, starting from a certain CSI priority reporting level in the used priority order of the CSI, there are insufficient uplink resources. The terminal equipment transmits information on bits of the number of bits that the uplink resources in information on the CSI report to which the CSI reporting level corresponds are sufficient to transmit, wherein the bits may traverse various possibilities (such as former K bits, latter K bits, a total K bits with even bits first and odd bits later, and a total K bits with odd bits first and even bits later, etc.). The terminal equipment drops/omits information on other bits of the information on the CSI report to which the CSI reporting level corresponds and information on all CSI report to which values larger than the priority reporting level correspond.

For example, the standards specify that the optional CSI priority orders are the three possibilities given in table 2. The terminal equipment has four transport layers. The bitwidths of the second information of the first, second, third and fourth transport layers are 120 bits, 100 bits, 80 bits and 80 bits, respectively. That is, the sum of the bitwidths of the second information of all the layers is 380 bits. For CSI report 3, a_₉=120, a_₁₀=80, a_₁₁=60, a_₁₂=40. The uplink resources of the second information of all layers available for CSI report 3 are less than 380 bits, assuming that they are 330 bits, they are 50 bits less than the sum of the bitwidths of the second information of all layers. The terminal equipment selects the CSI priority order given in column #1 of table 32 for CSI report, and reports information on the CSI priority order to a base station, which needs 2 bits. So there are still 330−2=328 bits of uplink resources available for the second information of all layers of CSI report 3. Uplink resources in the information on CSI report to which the priority reporting level corresponds transmitted by the terminal equipment are sufficient for transmitting bits of former K bits. According to the method in this example, CSI priority reporting level 24 (40 bits) is unable to be reported, and last 12 bits in CSI priority reporting level 23 are unable to be reported. In other words, former 8 bits in CSI priority reporting level 23 are reported, and remaining bits in CSI priority reporting level 23 and all bits in CSI priority reporting level 24 are omitted.

In this example, after receiving the report from the terminal equipment, according to contents in the report, the network device learns that the CSI priority order given in #1 column of table 2 is used for the CSI report. According to regulations in standards, the network device adds 12 “1” after a last bit of the received CSI of the third layer, and adds 40 “1” after a last bit of the received CSI of the fourth layer. Hence, the network device recovers channel information.

In this example, compared to the scheme of omitting all CSI in the third layer, in the scheme of omitting a part of CSI in the third layer, the part of information in the priority reporting level of the CSI where uplink resources are sufficient to report is reported. Therefore, all available uplink resources may be fully utilized.

In at least another embodiment of operation 302, the terminal equipment omits the first information of the CSI based on an omit criterion to which the first configuration information transmitted by the network device corresponds.

The omit criterion may include at least one parameter, the at least one parameter may include: the number of bits to which the omitted first information corresponds and/or positions of bits to which the omitted first information corresponds, and/or the number and/or positions of bits to which information reserved in the channel state information corresponds. The reserved information refers to information that needs to be reserved but not omitted in the operation of omitting the first information of the CSI by the terminal equipment.

The parameters in the omit criterion are predetermined parameters, or are obtained by configuring by the network device through parameter configuration information.

In at least one embodiment, the omit criterion may include at least one of the following:
omitting a former first number of bits in a bit sequence to which the layer of the second part corresponds;
omitting a latter second number of bits in the bit sequence;
omitting odd bits in the bit sequence first, and then omitting even bits in the bit sequence, until a total number of omitted bits is a third number;
omitting even bits in the bit sequence first, and then omitting odd bits in the bit sequence, until a total number of omitted bits is a fourth number; or
maintaining a (P*Q+R)-th bit in the bit sequence, and omitting the remaining bits; where, Q is a positive integer, P is an integer greater than or equal to 0, and R is a positive integer greater than or equal to 1 and less than Q.

Table 5 shows an example of the omit criterion.

TABLE 5

| | Configuration | Configuration | Configuration | Configuration | Configuration | Configuration |
|---|---|---|---|---|---|---|
| | 0 | 1 | 2 | 3 | 4 | 5 |
| omit | Part 2 of | Equal | Part 2 of the | Part 2 of | Pre-specified | In a case |
| criterion | the CSI of | numbers of | CSI of layer | the CSI of | numbers of | where there |
| | all layers in | bits in part | 1 in a piece | layers 1 and | bits in part | is only one |
| | a piece of | 2 of the CSI | of CSI | 2 in a piece | 2 of CSI of | layer in a |
| | CSI report | of all layers | report are | of CSI | layers in a | piece of CSI |
| | are not | in a piece of | all reserved, | report are | piece of CSI | report, the |
| | omitted. | CSI report | and equal | all reserved, | report are | number of |
| | | are | numbers of | and equal | reserved, | bits that are |
| | | reserved. | bits in part | numbers of | wherein | omitted is |
| | | | 2 of other | bits in part | numbers of | specified, |
| | | | layers in a | 2 of other | reserved bits | wherein the |
| | | | piece of CSI | layers in a | of at least | number of |
| | | | report are | piece of CSI | two layers | omitted bits |
| | | | reserved. | report are | are unequal. | may be 0, or |
| | | | | reserved. | | may be |
| | | | | | | greater than |
| | | | | | | 0. |

In the example to which table 5 corresponds, the network device may transmit the first configuration information to instruct the terminal equipment to omit the first information of the CSI based on an omit criterion to which any configuration in configuration 0 to configuration 5 corresponds.

In table 5, positions of the omitted bits and/or positions of the reserved bits may be agreed upon or configured by the network device. For example, they may be former K bits in a bit sequence, or may be latter K bits, or may be K bits after odd bits are omitted first and then even bits are omitted, or may be K bits after even bits are omitted first and then odd bits are omitted; however, it is not limited thereto. The positions of the omitted bits and/or positions of the reserved bits may be one of one or at least two agreed upon between the terminal equipment and the network device, or may be agreed upon in advance. For the case where they are configured by the network device, they may be indicated by index 7 configured by the network device, wherein a position of index 7 in the feedback bit sequence may be specified by standards or agreed upon in advance by the network device and the terminal equipment.

According to the embodiments of the first aspect of this disclosure, the first information of the CSI may be omitted according to the priority order of the CSI generated based on the artificial intelligence model and/or the first configuration information, thereby omitting the CSI generated based on the artificial intelligence model, and avoiding an ambiguity possibly generated when the network device reads the CSI.

### Embodiments of a Second Aspect

The embodiments of the second aspect provide a method for transmitting channel state information (CSI), applicable to a terminal equipment, such as the terminal equipment 202 in FIG. 2. For parts in the embodiments of the second aspect that are identical to those in the embodiments of the first aspect, reference may be made to the description in the embodiments of the first aspect, which shall not be repeated herein any further.

FIG. 4 is a schematic diagram of the method for transmitting channel state information (CSI) of the second aspect of this disclosure. As shown in FIG. 4, the method includes: operation 401: generating at least a portion of information of channel state information (CSI) according to an artificial intelligence model, wherein the CSI has priority orders.

Furthermore, as shown in FIG. 4, the method includes:
operation 402: the at least a portion of CSI is transmitted.

In some embodiments of operation 401, the at least a portion of CSI includes two parts: a first part and a second part, wherein the first part includes a rank indicator (RI) and/or at least a portion of a channel quality indicator (CQI) and/or a channel state information reference signal resource indicator (CRI), and the second part includes information on a precoding matrix and/or at least a portion of channel quality indicator (CQI) and/or a layer indicator (LI), wherein at least the information on the precoding matrix is generated based on the artificial intelligence model.

In at least one piece of channel state information report, the priority orders may be set according to information on a layer of the second part and/or information on predetermined bits in the layer.

In at least one embodiment, there may be one or at least two groups of mapping relationships between the priority orders and the information a layer and/or the information on predetermined bits in the layer. In the case where there are at least two groups of mapping relationships, the priority orders of the CSI may be set based on one of the at least two groups of mapping relationships.

The group of mapping relationships may be preset, or may be selected by the terminal equipment, or may be configured by the network device, wherein in the case where the group of mapping relationships is selected by the terminal equipment, the terminal equipment may transmit information on the selected group of mapping relationships to the network device.

In at least one embodiment, the information on a layer includes an order of the layer, wherein the order of the layer may be set according to an arrangement order of an eigenvalue or singular value of a spatial channel matrix to which the layer corresponds. For example, the larger the eigenvalue or singular value to which the layer corresponds, the higher the order of the layer.

In the CSI report, part 2 has one or at least two layers, and in the case where part 2 has at least two layers, the layers are generated based on identical artificial intelligence models, or, the at least two layers are generated based on different artificial intelligence models.

In at least another embodiment, the information on predetermined bits may include proportions of the predetermined bits in a bit sequence of the layer, and/or positions of the predetermined bits in the bit sequence. In the case where part 2 of the CSI report has at least two layers, for different layers, the proportions are identical, or, for the at least two layers, the proportions are different.

By multiplying a total number of bits in the bit sequence of the layer by the above proportions and rounding the result, the number of predetermined bits may be obtained.

In at least one further embodiment, the information on predetermined bits includes the number of the predetermined bits and/or positions of the predetermined bits in the bit sequence. In the case where part 2 of the CSI report has at least two layers, for different layers, the numbers of the predetermined bits are identical, or, for the at least two layers, the numbers of the predetermined bits are different.

In at least one embodiment, the information on predetermined bits may be preset information, or, the information on predetermined bits is configured by the network device, or, the information on predetermined bits is determined by the terminal equipment. In the case where the information on predetermined bits is determined by the terminal equipment, the terminal equipment further reports the information on predetermined bits to the network device.

According to the embodiments of the second aspect, for the CSI generated based on the artificial intelligence model, the priority order of the CSI may be set. Hence, the terminal equipment and the network device may perform corresponding processing and operations based on the priority order.

### Embodiments of a Third Aspect

Properties of a spatial channel between a terminal equipment and a network device will change due to different positions of the terminal equipment or other reasons, and important bits of a bit sequence of channel state information (CSI) obtained by the terminal equipment side based on an AI/ML model or other means are also different.

When uplink channel resources are insufficient, the terminal equipment may omit unimportant bits in the CSI. However, as important bits of the CDI may possibly be more than one groups, the network device is sometimes difficult to determine information on bits omitted by the terminal equipment.

The embodiments of the third aspect provides a method for transmitting channel state information (CSI), applicable to a terminal equipment, such as the terminal equipment 202 in FIG. 2. For parts in the embodiments of the third aspect that are identical to those in the embodiments of the first aspect, reference may be made to the description in the embodiments of the first aspect, which shall not be repeated herein any further.

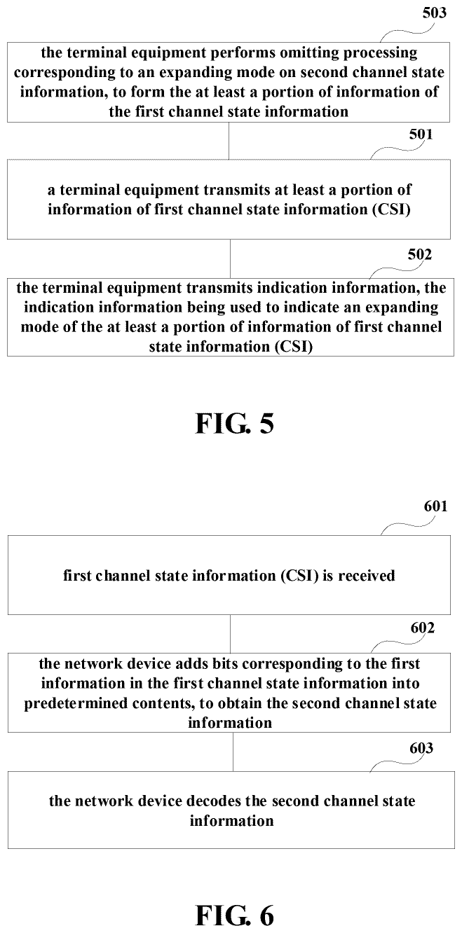

FIG. 5 is a schematic diagram of the method for transmitting channel state information (CSI) of the third aspect of this disclosure. As shown in FIG. 5, the method includes:
operation 501: a terminal equipment transmits at least a portion of information of first channel state information (CSI); and
operation 502: the terminal equipment transmits indication information; the indication information being used to indicate an expanding mode of the at least a portion of information of first channel state information (CSI).

In operation 501, the at least a portion of information of the first CSI may be, for example, a CSI payload, that is, the CSI payload may be all information of the first CSI, or may be a portion of information of the first CSI.

In the embodiments of the third aspect, the terminal equipment transmits indication information to the network device, so that the network device may expand the received CSI according to the received indication information, thereby facilitating subsequent processing of the terminal equipment.

As shown in FIG. 5, the method further includes:

operation 503: the terminal equipment performs omitting processing on second channel state information corresponding to the expanding mode, to form the at least a portion of information of the first channel state information.

In operation 503, the omitting processing is, for example, omitting some bits in the second channel state information (CSI), etc. The second CSI is, for example, output by an AI/ML model at the terminal equipment side, or is generated based on related codebook. A method for generating the second CSI is not limited in this disclosure.

In the embodiments of the third aspect, the terminal equipment performs omitting processing on the second CSI, transmits at least a portion of information of the first CSI obtained by the omitting processing to the network device, and transmits the indication information of the expanding mode to which the omitting processing corresponds to the network device. Hence, the network device may perform expanding processing on the received at least a portion of information of the first CSI (such as padding the bits omitted by the terminal equipment with 0 or 1 or a predetermined bit sequence, such as 10011, etc.), thereby obtaining expanded CSI.

In at least one embodiment, the expanding mode indicated by the indication information includes:
the number of expanded bits, and/or contents of the expanded bits, and/or positions of the expanded bits in the channel state information, etc.

The number and/or positions of the expanded bits may be at least one.

For example, the expanded bits may be located at foremost positions of the at least a portion of information of the first CSI, or may be located at rearmost positions thereof, or may be expanded between two bits (such as being expanded by aᵢ≥0 bits between a pᵢ-th bit and a (pᵢ+1)-th bit, where, i is a positive integer; and these a; may all be identical, or at least two of them are different).

The contents the expanded bits may be at least one.

For example, 0 may be added to all the expanded bits, or 1 may be added to all the expanded bits, or a pre-agreed group of bit sequences may be added to the expanded bits, for example, y=10011 . . . ; however, it is not limited thereto. A length of the added bit sequence is dependent on a sum of all the above aᵢ. For one i, aᵢ bits of sequence y are added to corresponding positions of the at least a portion of information of the first CSI in an order of the sequence y from left to right.

Correspondingly, contents of the omitting processing corresponding to the expanding mode may include:
the number of omitted bits, and/or contents of the omitted bits, and/or positions of the omitted bits in the channel state information, etc.

In at least one embodiment, the expanding mode may be at least one of at least two candidate expanding modes, and the indication information may include an index of the candidate expanding mode, thereby indicating the expanding mode. The at least two candidate expanding modes are predefined, or are configured by the network device.

In at least one embodiment, in at least one piece of channel state information report, the at least a portion of the first channel state information has one layer or at least two layers. In the case where the at least a portion of the first CSI has at least two layers, expanding modes of the layers may be identical, or expanding modes of the at least two layers are different. For example, in the case where it has at least two layers, the layers may have respective indication information indicating expanding modes of the layers, that is, the number of pieces of the indication information may be identical to the number of the layers. For another example, in the case where it has at least two layers, layers with identical expanding modes may share indication information used to indicate an expanding mode.

In at least one embodiments of operation 502, the number and/or positions of bits of resources used to transmit the indication information is/are predefined, or configured by the network device. For example, 3 bits may be used to transmit the indication information, and the bits used to transmit the indication information may be located at the front or rear of the at least a portion of information of the first CSI, or may be located at other predetermined positions.

The method for transmitting channel state information of the third aspect shall be described below by way of examples. In the following embodiments, the number and/or positions of the bits of the resources used to transmit the indication information is/are predefined, or configured by the network device.

### Implementation 1:

Assuming that a CSI uplink channel PUSCH resource configured by the network device is 80 bits, in which 77 bits are used for the CSI payload (i.e. the at least a portion of information of the first CSI), and 3 bits are used for transmitting the indication information, the indication information being used to indicate an expanding mode of the CSI payload. The 3 bits used to indicate the expanding mode are located at last three bits of the 80 bits.

A CSI encoder based on an AI/ML model at the terminal equipment side and a CSI decoder based on an AI/ML model at the network device side have been jointly trained, and output of the encoder and input of the decoder are both 100 bits.

N is a value obtained by subtracting the number of output bits of the encoder by the number of bits of the CSI payload. There are 8 candidate expanding modes for expanding the CSI payload, corresponding to indication information of 3 bits:
1. adding n 0s at a foremost position;
2. adding n 1s at a rearmost position;
3. adding 0 between every two bits in 1st to (n+1)-th bits of the CSI payload;
4. adding 0 between every two bits in 1st to the (n+1)-th to last bits of the CSI payload;
5. adding 0 respectively to the 1st, a 3rd, a 5th, a 7th, . . . (2n−1)-th bits of the CSI payload;
6. adding 0 respectively to the 1st to last, a 3rd to last, a 5th to last, a 7th to last, . . . (2n−1)-th to last bits of the CSI payload;
7. adding two 0 to the 1st bit, and adding 0 respectively to the 3rd, the 5th, a 37th, (2n−3)-th bits of the CSI payload;
8. defining a sequence x with a length of m in advance, such as 10011001111 . . . 001101110, and adding a 1st, 2nd, 3rd, 4th, n-th bits of the sequence x respectively to the 1st, 3rd, 5th, 7th, . . .
(2n−1)-th bits of the CSI payload.

In example 1, 0<n<m.

The indication information of 3 bits to which the first to eighth candidate expanding modes respectively correspond may be 000, 001, 010, 011, 100, 101, 110, 111, respectively.

As the uplink resource is 80 bits, in this example, n=23. Before transmitting the CSI payload to the network device via the uplink channel, the terminal equipment selects one of the eight candidate expanding modes as the expanding mode, such as selecting the eighth mode. Hence, according to the selected expanding mode, the terminal equipment omits a 2nd, 4th, 6th, 8th, . . . , 44th and 46th bits for a bit sequence with a length of 100 bits output by the encoder (the bit sequence with a length of 100 bits corresponds to the second CSI), thereby obtaining a bit sequence with a length of 77 bits. The terminal equipment takes “111” as the indication information to indicate the expanding mode, and attaches the bit sequence of 3 bits after the previously obtained bit sequence of 77 bits to obtain a bit sequence of 80 bits. The terminal equipment uploads the bit sequence of 80 bits via an uplink channel (e.g. a PUSCH).

The network device receives the bit sequence of 80 bits, and may learn according to its own specifications that a bit sequence indicating an expanding format exists. The bit sequence is 3 bits in length and is located at the last 3 bits of the 80 bits received by the network device. The network device reads the last 3 bits and obtains 111, hence, the network device learns to use the above candidate expanding mode 8 to extend a sequence of former 77 bits received by the network device. Through the expansion, the network device obtains a bit sequence with a length of 100, and the bit sequence with a length of 100 is input to the decoder, thus, information output by the decoder is recovery of information input to the encoder.

### Implementation 2:

In Implementation 2, as shown in table 6, the indication information used to indicate n expanding mode may be combined with the priority order of the CSI. For example, the information on predetermined bits in the embodiments of the first aspect may be set based on the expanding mode, that is, there may exist a mapping relationship between the priority order and the information on a layer and/or information on bits set according to the expanding mode.

It is assumed that there are three pieces of CSI report, each corresponding to 2 layers. However, this embodiment is not limited thereto, for example, numbers of layers to which at least two pieces of CSI report correspond may be different.

One of the eight candidate expanding modes in Implementation 1 may be selected as a mode for extending the CSI payload (i.e. the at least a portion of information of the first CSI) for each layer. Identical expanding modes may be selected for the layers, or different expanding modes may be selected for at least two layers.

TABLE 6

| | #1 | #2 |
|---|---|---|
| Priority | Modes for expanding the CSI payload indicated in CSI report | |
| order 0 | 1-3 (for example, each CSI report has 2 layers, and modes for | |
| | expanding the CSI payload of the layers (which may be | |
| | identical, or those for at least two layers are different) | |
| | are described by 3 bits, and there are total 18bits) | |
| Priority | Bits reserved by layer 1 in CSI report 1 | Description |
| order 1 | according to a selected mode for | omitted |
| | “expanding a CSI payload” | |
| Priority | Bits omitted by layer 1 in CSI report 1 | |
| order 2 | according to a selected mode for | |
| | “expanding a CSI payload” | |
| Priority | Bits reserved by layer 2 in CSI report 1 | |
| order 3 | according to a selected mode for | |
| | “expanding a CSI payload” | |
| Priority | Bits omitted by layer 2 in CSI report 1 | |
| order 4 | according to a selected mode for | |
| | “expanding a CSI payload” | |
| Priority | Bits reserved by layer 1 in CSI report 2 | |
| order 5 | according to a selected mode for | |
| | “expanding a CSI payload” | |
| Priority | Bits omitted by layer 1 in CSI report 2 | |
| order 6 | according to a selected mode for | |
| | “expanding a CSI payload” | |
| Priority | Bits reserved by layer 2 in CSI report 2 | |
| order 7 | according to a selected mode for | |
| | “expanding a CSI payload” | |
| Priority | Bits omitted by layer 2 in CSI report 2 | |
| order 8 | according to a selected mode for | |
| | “expanding a CSI payload” | |
| Priority | Bits reserved by layer 1 in CSI report 3 | |
| order 9 | according to a selected mode for | |
| | “expanding a CSI payload” | |
| Priority | Bits omitted by layer 1 in CSI report 3 | |
| order 10 | according to a selected mode for | |
| | “expanding a CSI payload” | |
| Priority | Bits reserved by layer 2 in CSI report 3 | |
| order 11 | according to a selected mode for | |
| | “expanding a CSI payload” | |
| Priority | Bits omitted by layer 2 in CSI report 3 | |
| order 12 | according to a selected mode for | |
| | “expanding a CSI payload” | |

In table 6, the bits reserved according to the selected mode for “expanding a CSI payload” refer to bits reserved in the CSI payload after performing omitting processing by the terminal equipment based on the selected expanding mode.

In table 6, the bits omitted according to the selected mode for “expanding a CSI payload” refer to bits omitted from the second CSI when the terminal equipment performs omitting processing based on the selected expanding mode.

In table 6, indication information used to indicate “a mode for expanding a CSI payload” in the three pieces of CSI reports is set to have a highest priority order, i.e. priority order 0.

In some implementations, the priority order of the CSI may only have one specification, and there exists only one column of mapping relationship in table 6, such as corresponding to #1 or #2.

In some other implementations, the priority order of the CSI may have two specifications, and there exist at least two columns of mapping relationships in table 6, such as corresponding to #1 and #2. The terminal equipment may determine according to configuration of the network device which group of mapping relationships is used to set the priority order of the CSI and omit the CSI; or, the terminal equipment may determine by itself which group of mapping relationships is used to set the priority order of the CSI, omit the CSI, and feed back indices of the group of mapping relationships to the network device. Positions of the indices of the mapping relationships in the feedback bit sequence may be provided in standards or agreed upon in advance by the network device and the terminal equipment.

### Implementation 3:

Implementation 3 is similar to implementation 2.

In implementation 3, all layers in the same CSI report use identical “modes for expanding a CSI payload”.

In implementation 2, each CSI report has 2 layers, and each layer has separate indication information to indicate “a mode for extending a CSI payload”. The indication information is 3 bits, hence, each CSI report needs 6 bits to indicate “a mode for extending a CSI payload”.

In implementation 3, each CSI report has 2 layers, and the two layers may share a piece of indication information to indicate “a mode for extending a CSI payload”. The indication information is 3 bits, hence, each CSI report needs 3 bits to indicate “a mode for extending a CSI payload”. Positions of the 3-bit indication information may be predefined, or may be configured by the network device. For example, the 3 bits may be located after the CSI payload of the first layer or may be located at other positions.

### Implementation 4:

Implementation 4 is similar to implementation 3, with an exception that in implementation 4, different pieces of CSI report may have different numbers of layers.

In implementation 4, as shown in table 7, all layers in the same CSI report use identical “modes for expanding a CSI payload”.

In implementation 4, the indication information of the three pieces of CSI report used to indicate “a mode for extending a CSI payload” is not set to have a highest priority order.

TABLE 7

| | #1 | #2 |
|---|---|---|
| Priority | Bits reserved by layer 1 in CSI report 1 | Description |
| order 1 | according to a selected “mode for | omitted |
| | expanding a CSI payload”, and a “mode | |
| | for expanding a CSI payload” | |
| Priority | Bits omitted by layer 1 in CSI report 1 | |
| order 2 | according to a selected “mode for | |
| | expanding a CSI payload” | |
| Priority | Bits reserved by layer 2 in CSI report 1 | |
| order 3 | according to a selected “mode for | |
| | expanding a CSI payload” | |
| Priority | Bits omitted by layer 2 in CSI report 1 | |
| order 4 | according to a selected “mode for | |
| | expanding a CSI payload” | |
| Priority | Bits reserved by layer 1 in CSI report 2 | |
| order 5 | according to a selected “mode for | |
| | expanding a CSI payload”, and a “mode | |
| | for expanding a CSI payload” | |
| Priority | Bits omitted by layer 1 in CSI report 2 | |
| order 6 | according to a selected mode for | |
| | “expanding a CSI payload” | |
| Priority | Bits reserved by layer 2 in CSI report 2 | |
| order 7 | according to a selected “mode for | |
| | expanding a CSI payload” | |
| Priority | Bits omitted by layer 2 in CSI report 2 | |
| order 8 | according to a selected “mode for | |
| | expanding a CSI payload” | |
| Priority | Bits reserved by layer 3 in CSI report 2 | |
| order 9 | according to a selected “mode for | |
| | expanding a CSI payload” | |
| Priority | Bits omitted by layer 3 in CSI report 2 | |
| order 10 | according to a selected “mode for | |
| | expanding a CSI payload” | |
| Priority | Bits reserved by layer 1 in CSI report 3 | |
| order 11 | according to a selected “mode for | |
| | expanding a CSI payload”, and a “mode | |
| | for expanding a CSI payload” | |
| Priority | Bits omitted by layer 1 in CSI report 3 | |
| order 12 | according to a selected “mode for | |
| | expanding a CSI payload” | |
| Priority | Bits reserved by layer 2 in CSI report 3 | |
| order 13 | according to a selected “mode for | |
| | expanding a CSI payload” | |
| Priority | Bits omitted by layer 2 in CSI report 3 | |
| order 14 | according to a selected “mode for | |
| | expanding a CSI payload” | |

At least a portion of contents of the priority sequence shown in column #1 in table 7 are adjusted, and may be taken as the mapping relationship of #2.

In some implementations, the priority order of the CSI may only have one specification, for example, there exists only one column of mapping relationship in table 7, such as corresponding to #1 or #2.

In some other implementations, the priority order of the CSI may have at least two specifications, for example, there exist at least two columns of mapping relationships in table 7, such as corresponding to #1 and #2. The terminal equipment may determine according to configuration of the network device which group of mapping relationships is used to set the priority order of the CSI and omit the CSI; or, the terminal equipment may determine by itself which group of mapping relationships is used to set the priority order of the CSI, omit the CSI, and feed back indices of the group of mapping relationships to the network device. Positions of the indices of the mapping relationships in the feedback bit sequence may be provided in standards or agreed upon in advance by the network device and the terminal equipment.

Embodiments of a fourth aspect (corresponding to the first aspect, at a network side)

At least addressed to the same issues as the embodiments of the first aspect, the embodiments of the fourth aspect of this disclosure provides a method for receiving channel state information (CSI), which is applicable to a network device, and corresponds to the embodiments of the first aspect.

FIG. 6 is a schematic diagram of the method for receiving channel state information of the embodiments of the fourth aspect, the method including:
operation 601: first channel state information (CSI) is received.

The first channel state information is obtained by omitting first information from at least a portion of information of the channel state information (CSI) generated based on an artificial intelligence model according to priority orders of channel state information and/or first configuration information.

In at least one embodiment, the at least a portion of the channel state information includes two parts, wherein in the two parts,
a first part includes a rank indicator (RI) and/or at least a portion of a channel quality indicator (CQI) and/or a channel state information reference signal resource indicator (CRI), a second part includes information on a precoding matrix and/or at least a portion of channel quality indicator (CQI) and/or a layer indicator (LI), wherein at least the information on the precoding matrix is generated based on the artificial intelligence model, and the first information is at least a portion of information in the second part.

In at least one embodiment, the omitting first information of the channel state information according to priority orders includes:
omitting the first information of the channel state information in an ascending order of the priority orders.

In at least one embodiment, in at least one piece of channel state information report, the priority orders are set according to information on a layer of the second part and/or information on predetermined bits in the layer.

In at least one embodiment, there is one or at least two groups of mapping relations between the priority orders and the information on the layers and/or the information on predetermined bits in the layer. In a case where there are at least two groups of mapping relations, the priority orders are set based on one of at least two groups of mapping relations. The group of mapping relationships is preset, or is selected by the terminal equipment, or is configured by the network device.

In at least one embodiment, in the case where the group of mapping relationships is selected by the terminal equipment, the network device receives information on the group of mapping relationships transmitted by the terminal equipment.

In at least one embodiment, the information on the layers includes an order of the layers, the order of the layers being set according to arrangement orders of eigenvalues or singular values of spatial channel matrices to which the layers correspond. The larger the eigenvalues or singular values, the higher the order of the layer.

In at least one embodiment, in the CSI report, the second part includes one of or at least two of the layers, and in a case where the second part includes at least two of the layers, the layers are generated based on identical artificial intelligence models, or the at least two of the layers are generated based on different artificial intelligence models.

In at least one embodiment, the information on the predetermined bits includes a proportion of the predetermined bits in a bit sequence of the layers. In the case where part 2 of the CSI report has at least two layers, for different layers, the proportions are identical, or, for the at least two layers, the proportions are different.

In at least one embodiment, the number of the predetermined bits is the number of bits obtained by multiplying a total number of bits in the bit sequence of the layer by the proportion and rounding the result.

In at least one embodiment, the information on the predetermined bit further includes positions of the predetermined bits in the bit sequence.

In at least one embodiment, the information on the predetermined bit includes the number of the predetermined bits. In the case where part 2 of the CSI report has at least two layers, for different layers, the numbers of the predetermined bits are identical; or, for the at least two layers, the numbers of the predetermined bits are different.

The information on predetermined bits further includes positions of the predetermined bits in the bit sequence.

In at least one embodiment, the information on the predetermined bits is preset information, or the information on the predetermined bits is configured by the network device, or the information on the predetermined bits is determined by the terminal equipment.

In the case where the information on the predetermined bits is determined by the terminal equipment, the network device receives the information on the predetermined bits transmitted by the terminal equipment.

In at least one embodiment, the terminal equipment omits the first information of the CSI based on an omit criterion to which the first configuration information corresponds.

Parameters in the omit criterion include:
the number and/or positions of bits to which the omitted first information corresponds; and/or
the number and/or positions of bits to which information reserved in the channel state information corresponds.

The parameters in the omit criterion are predetermined parameters, or are configured by the network device via parameter configuration information.

The omit criterion includes at least one of the following:
omitting former first number of bits in the bit sequence to which the layer corresponds;
omitting latter second number of bits in the bit sequence;
omitting odd bits in the bit sequence first, then omitting even bits in the bit sequence, until a total number of omitted bits is a third number;
omitting even bits in the bit sequence first, then omitting odd bits in the bit sequence, until a total number of omitted bits is fourth number; or
reserving a (P*Q+R)-th bit of the bit sequence, and omitting the remaining bits; where, Q is a positive integer, P is an integer greater than or equal to 0, and R is a positive integer greater than or equal to 1 and less than M.

In at least one embodiment, the omitting occurs in CSI report carried by a physical uplink shared channel (PUSCH) and/or CSI report carried by a physical uplink control channel (PUCCH).

As shown in FIG. 6, the method further includes:

operation 602: the network device adds bits in the first channel state information corresponding to the first information into predetermined contents, to obtain the second channel state information; and operation 603: the network device decodes the second channel state information.

### Embodiments of a Fifth Aspect

At least addressed to the same issues as the embodiments of the second aspect, the embodiments of the fifth aspect of this disclosure provide a method for receiving channel state information (CSI), which is applicable to a network device, and corresponds to the embodiments of the second aspect.

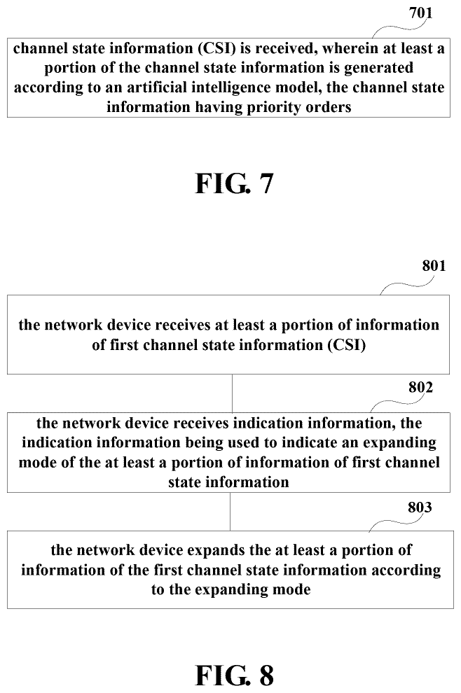

FIG. 7 is a schematic diagram of the method for receiving channel state information of the embodiments of the fifth aspect, the method including:
operation 701: channel state information (CSI) is received, wherein at least a portion of information of the channel state information is generated based on an artificial intelligence model, the channel state information having priority orders.

In at least one embodiment, the at least a portion of CSI includes two parts, wherein in the two parts, a first part includes a rank indicator (RI) and/or at least a portion of a channel quality indicator (CQI) and/or a channel state information reference signal resource indicator (CRI), and the second part includes information on a precoding matrix and/or at least a portion of channel quality indicator (CQI) and/or a layer indicator (LI), wherein at least the information on the precoding matrix is generated based on the artificial intelligence model.

In at least one piece of channel state information report, the priority orders may be set according to information on a layer of the second part and/or information on predetermined bits in the layer.

There may be one or at least two groups of mapping relationships between the priority orders and the information a layer and/or the information on predetermined bits in the layer. In the case where there are at least two groups of mapping relationships, the priority orders of the CSI may be set based on one of the at least two groups of mapping relationships.

The group of mapping relationships may be preset, or may be selected by the terminal equipment, or may be configured by the network device; wherein in the case where the group of mapping relationships is selected by the terminal equipment, the network device receives information on the selected group of mapping relationships transmitted by the terminal equipment.

The information on a layer includes an order of the layer, wherein the order of the layer may be set according to an arrangement order of an eigenvalue or singular value of a spatial channel matrix to which the layer corresponds. The larger the eigenvalue or singular value, the higher the order of the layer.

In the CSI report, part 2 has one or at least two layers, and in the case where part 2 has at least two layers, the layers are generated based on identical artificial intelligence models, or, the at least two layers are generated based on different artificial intelligence models.

In at least one embodiment, the information on predetermined bits may include proportions of the predetermined bits in a bit sequence of the layer, and/or positions of the predetermined bits in the bit sequence. In the case where part 2 of the CSI report has at least two layers, for different layers, the proportions are identical, or, for the at least two layers, the proportions are different.

The number of predetermined bits is the number of bits obtained by multiplying a total number of bits in the bit sequence of the layer by the proportions and rounding the result.

In at least one another embodiment, the information on predetermined bits includes the number of the predetermined bits and/or positions of the predetermined bits in the bit sequence. In the case where part 2 of the CSI report has at least two layers, for different layers, the numbers of the predetermined bits are identical, or, for the at least two layers, the numbers of the predetermined bits are different.

In at least one embodiment, the information on predetermined bits may be preset information, or, the information on predetermined bits is configured by the network device, or, the information on predetermined bits is determined by the terminal equipment. In the case where the information on predetermined bits is determined by the terminal equipment, the network device further receives the information on predetermined bits reported by the terminal equipment.

### Embodiments of a Sixth Aspect

At least addressed to the same issues as the embodiments of the third aspect, the embodiments of the sixth aspect of this disclosure provides a method for receiving channel state information (CSI), which is applicable to a network device, and corresponds to the embodiments of the third aspect.

FIG. 8 is a schematic diagram of the method for receiving channel state information of the embodiments of the sixth aspect, the method including:
operation 801: the network device receives at least a portion of information of first channel state information (CSI); and
operation 802: the network device receives indication information; the indication information being used to indicate an expanding mode of the at least a portion of information of first channel state information.

In at least one embodiment, the number and/or positions of bits of a resource used for receiving the indication information is/are predefined, or is/are configured by the network device.

In at least one embodiment, the expanding mode includes:
the number of expanded bits, and/or contents of the expanded bits, and/or positions of the expanded bits in the channel state information.

In at least one embodiment, the expanding mode may be at least one of at least two candidate expanding modes. The at least two candidate expanding modes are predefined, or are configured by the network device.

In at least one embodiment, as shown in FIG. 8, the method further includes:
operation 803: the network device expands the at least a portion of information of the first channel state information according to the expanding mode.

In at least one embodiment, in at least one piece of channel state information report, the at least a portion of the first channel state information has one layer or at least two layers. In the case where the at least a portion of the first CSI has at least two layers, expanding modes of the layers may be identical, or expanding modes of the at least two layers are different. In the case where it has at least two layers, layers with identical expanding modes may share a piece of indication information.

### Embodiments of a Seventh Aspect

The embodiments of the seventh aspect of this disclosure provide an apparatus for transmitting channel state information (CSI), which is applicable to a terminal equipment, and corresponds to the embodiments of the first aspect.

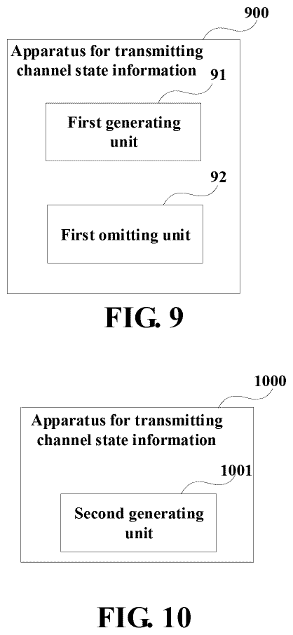

FIG. 9 is a schematic diagram of the apparatus for transmitting channel state information of the embodiments of the seventh aspect. As shown in FIG. 9, an apparatus 900 includes:
a first generating unit 91 configured to generate at least a portion of information of channel state information (CSI) according to an artificial intelligence model; and
a first omitting unit 92 configured to omit first information of the channel state information according to priority orders of the channel state information and/or first configuration information.

The at least a portion of the channel state information includes two parts, wherein in the two parts,
a first part includes a rank indicator (RI) and/or at least a portion of a channel quality indicator (CQI) and/or a channel state information reference signal resource indicator (CRI), a second part includes information on a precoding matrix and/or at least a portion of channel quality indicator (CQI) and/or a layer indicator (LI), wherein at least the information on the precoding matrix is generated based on the artificial intelligence model, and the first information is at least a portion of information in the second part.

The first omitting unit 92 omits the first information of the channel state information in an ascending order of the priority orders. For example, the omitted first information is all or a part of the channel state information to which at least one priority reporting level in the priority orders corresponds.

In at least one piece of channel state information report, the priority orders are set according to information on a layer of the second part and/or information on predetermined bits in the layer.

There is one or at least two groups of mapping relations between the priority orders and the information on the layers and/or the information on predetermined bits in the layer, and in a case where there are at least two groups of mapping relations, the priority orders are set based on one of at least two groups of mapping relations. The group of mapping relationships is preset, or is selected by the terminal equipment, or is configured by the network device. In the case where the group of mapping relationships is selected by the terminal equipment, the apparatus 900 is configured to transmit information on the group of mapping relationships to the network device.

In at least one embodiment, the information on the layers includes an order of the layers, the order of the layers being set according to arrangement orders of eigenvalues or singular values of spatial channel matrices to which the layers correspond. For example, the larger the eigenvalue or singular value, the higher the order of the layer to which the layer corresponds.

In the CSI report, the second part includes one of or at least two of the layers. In a case where the second part includes at least two of the layers, the layers are generated based on identical artificial intelligence models, or the at least two of the layers are generated based on different artificial intelligence models.

In at least one embodiment, the information on the predetermined bits includes a proportion of the predetermined bits in a bit sequence of the layers and/or positions of the predetermined bits in the bit sequence.

In the case where the second part of the CSI report has at least two layers, for different layers, the proportions are identical, or, for the at least two layers, the proportions are different. The number of predetermined bits is the number of bits obtained by multiplying a total number of bits in the bit sequence of the layer by the proportions and rounding the result.

In at least another embodiment, the information on predetermined bits includes the number of the predetermined bits and/or positions of the predetermined bits in the bit sequence.

In the case where second part of the CSI report has at least two layers, for different layers, the numbers of the predetermined bits are identical, or, for the at least two layers, the numbers of the predetermined bits are different.

In at least another embodiment, the information on the predetermined bits is preset information, or the information on the predetermined bits is configured by the network device, or the information on the predetermined bits is determined by the terminal equipment.

In the case where the information on predetermined bits is determined by the terminal equipment, the apparatus 900 further reports the information on predetermined bits to the network device.

In at least one embodiment, the first omitting unit 92 is configured to omit the first information of the CSI based on an omit criterion to which the first configuration information corresponds.

Parameters in the omit criterion include:
the number and/or positions of bits to which the omitted first information corresponds; and/or
the number and/or positions of bits to which information reserved in the channel state information corresponds.

The parameters in the omit criterion are predetermined parameters, or are obtained by configuring by the network device through parameter configuration information.

In at least one embodiment, the omit criterion includes at least one of the following:
omitting a former first number of bits in a bit sequence to which the layer of the second part corresponds;
omitting a latter second number of bits in the bit sequence;
omitting odd bits in the bit sequence first, and then omitting even bits in the bit sequence, until a total number of omitted bits is a third number;
omitting even bits in the bit sequence first, and then omitting odd bits in the bit sequence, until a total number of omitted bits is a fourth number;
maintaining a (P*Q+R)-th bit in the bit sequence, and omitting the remaining bits; where, Q is a positive integer, P is an integer greater than or equal to 0, and R is a positive integer greater than or equal to 1 and less than Q.

In at least one embodiment, the omitting by the first omitting unit 92 occurs in CSI report carried by a physical uplink shared channel (PUSCH) and/or CSI report carried by a physical uplink control channel (PUCCH).

### Embodiments of an Eighth Aspect

The embodiments of the eighth aspect of this disclosure provide an apparatus for transmitting channel state information (CSI), which is applicable to a terminal equipment, and corresponds to the embodiments of the second aspect.

FIG. 10 is a schematic diagram of the apparatus for transmitting channel state information of the embodiments of the eighth aspect. As shown in FIG. 10, an apparatus 1000 includes:
a second generating unit 1001 configured to generate at least a portion of information of channel state information (CSI) according to an artificial intelligence model, wherein the channel state information has priority orders.

The at least a portion of the channel state information includes two parts, in the two parts:
a first part includes a rank indicator (RI) and/or at least a portion of a channel quality indicator (CQI) and/or a channel state information reference signal resource indicator (CRI), and a second part includes information on a precoding matrix and/or at least a portion of channel quality indicator (CQI) and/or a layer indicator (LI), wherein at least the information on the precoding matrix is generated based on the artificial intelligence model.

In at least one piece of CSI report, the priority orders are set according to information on a layer of the second part and/or information on predetermined bits in the layer.

There is one or at least two groups of mapping relations between the priority orders and the information on the layers and/or the information on predetermined bits in the layer, and in a case where there are at least two groups of mapping relations, the priority orders are set based on one of at least two groups of mapping relations. The group of mapping relationships is preset, or is selected by the terminal equipment, or is configured by the network device. In the case where the group of mapping relationships is selected by the terminal equipment, the apparatus 1000 is configured to transmit information on the group of mapping relationships to the network device.

In at least one embodiment, the information on the layers includes an order of the layers, the order of the layers being set according to arrangement orders of eigenvalues or singular values of spatial channel matrices to which the layers correspond. For example, the larger the eigenvalue or singular value, the higher the order of the layer to which the layer corresponds.

In the CSI report, the second part has one or at least two layers, and in the case where the second part has at least two layers, the layers are generated based on identical artificial intelligence models, or, the at least two layers are generated based on different artificial intelligence models.

In at least one embodiment, the information on predetermined bits includes proportions of the predetermined bits in a bit sequence of the layer, and/or positions of the predetermined bits in the bit sequence.

In the case where the second part of the CSI report has at least two layers, for different layers, the proportions are identical, or, for the at least two layers, the proportions are different. The number of predetermined bits is the number of bits obtained by multiplying a total number of bits in the bit sequence of the layer by the proportions and rounding the result.

In at least one another embodiment, the information on predetermined bits includes the number of the predetermined bits and/or positions of the predetermined bits in the bit sequence.

In the case where the second part of the CSI report has at least two layers,
for different layers, the numbers of the predetermined bits are identical, or, for the at least two layers, the numbers of the predetermined bits are different.

In at least one embodiment, the information on predetermined bits is preset information, or, the information on predetermined bits is configured by the network device, or, the information on predetermined bits is determined by the terminal equipment.

In the case where the information on predetermined bits is determined by the terminal equipment, the apparatus 1000 further reports the information on predetermined bits to the network device.

### Embodiments of a Ninth Aspect

The embodiments of the ninth aspect of this disclosure provide an apparatus for transmitting channel state information (CSI), which is applicable to a terminal equipment, and corresponds to the embodiments of the third aspect.

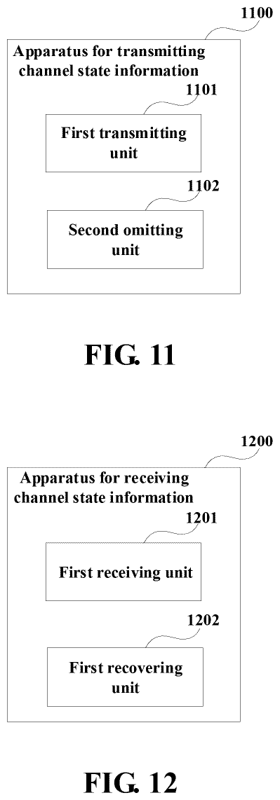

FIG. 11 is a schematic diagram of the apparatus for transmitting channel state information of the embodiments of the ninth aspect. As shown in FIG. 11, an apparatus 1100 includes a first transmitting unit 1101, the first transmitting unit 1101 being configured to: transmit at least a portion of information of first channel state information (CSI); and transmit indication information, the indication information being used to indicate an expanding mode of the at least a portion of information of first channel state information (CSI).

The number and/or positions of bits of resources used to transmit the indication information is/are predefined, or configured by the network device.

In at least one embodiment, the expanding mode includes:
the number of expanded bits, and/or contents of the expanded bits, and/or positions of the expanded bits in the channel state information.

The expanding mode is one of at least two candidate expanding modes, and the at least two candidate expanding modes are predefined, or are configured by the network device.

As shown in FIG. 11, the apparatus 1100 further includes:
a second omitting unit 1102 configured to perform omitting processing on second channel state information corresponding to the expanding mode, so as to form the at least a portion of information of the first channel state information.

In at least one embodiment, in at least one piece of channel state information report, the at least a portion of the first channel state information has one layer or at least two layers. In the case where the at least a portion of the first CSI has at least two layers, expanding modes of the layers may be identical, or expanding modes of the at least two layers are different. In the case where it has at least two layers, layers with identical expanding modes may share the indication information.

### Embodiments of a Tenth Aspect

The embodiments of the tenth aspect of this disclosure provide an apparatus for receiving channel state information (CSI), which is applicable to a network device, and corresponds to the embodiments of the fourth aspect.

FIG. 12 is a schematic diagram of the apparatus for receiving channel state information of the embodiments of the fourth aspect. As shown in FIG. 12, an apparatus 1200 includes:
a first receiving unit 1201 configured to receive first channel state information (CSI), wherein the first channel state information is obtained by omitting first information from at least a portion of information of the channel state information (CSI) generated based on an artificial intelligence model according to priority orders of channel state information and/or first configuration information.

In at least one embodiment, the at least a portion of the channel state information includes two parts, wherein in the two parts, a first part includes a rank indicator (RI) and/or at least a portion of a channel quality indicator (CQI) and/or a channel state information reference signal resource indicator (CRI), a second part includes information on a precoding matrix and/or at least a portion of channel quality indicator (CQI) and/or a layer indicator (LI), wherein at least the information on the precoding matrix is generated based on the artificial intelligence model, and the first information is at least a portion of information in the second part.

In at least one embodiment, the omitting first information of the channel state information according to priority orders includes:
omitting the first information of the channel state information in an ascending order of the priority orders.

In at least one piece of CSI report, the priority orders are set according to information on a layer of the second part and/or information on predetermined bits in the layer. There is one or at least two groups of mapping relations between the priority orders and the information on the layers and/or the information on predetermined bits in the layer. In a case where there are at least two groups of mapping relations, the priority orders are set based on one of at least two groups of mapping relations.

The group of mapping relationships is preset, or is selected by the terminal equipment, or is configured by the network device. In the case where the group of mapping relationships is selected by the terminal equipment, the network device receives information on the group of mapping relationships transmitted by the terminal equipment.

In at least one embodiment, the information on the layers includes an order of the layers, the order of the layers being set according to arrangement orders of eigenvalues or singular values of spatial channel matrices to which the layers correspond. The larger the eigenvalues or singular values, the higher the priority order to which the layer corresponds.

In the CSI report, the second part includes one of or at least two of the layers, and in a case where the second part includes at least two of the layers, the layers are generated based on identical artificial intelligence models, or the at least two of the layers are generated based on different artificial intelligence models.

In at least one embodiment, the information on the predetermined bits includes a proportion of the predetermined bits in a bit sequence of the layers and/or positions of the predetermined bits in the bit sequence.

In the case where the second part of the CSI report has at least two layers, for different layers, the proportions are identical, or, for the at least two layers, the proportions are different.

The number of the predetermined bits is the number of bits obtained by multiplying a total number of bits in the bit sequence of the layer by the proportion and rounding the result.

In at least one other embodiment, the information on the predetermined bit includes the number of the predetermined bits and/or positions of the predetermined bits in the bit sequence.

In the case where the second part of the CSI report has at least two layers, for different layers, the numbers of the predetermined bits are identical; or, for the at least two layers, the numbers of the predetermined bits are different.

In at least one embodiment, the information on the predetermined bits is preset information, or the information on the predetermined bits is configured by the network device, or the information on the predetermined bits is determined by the terminal equipment. In the case where the information on the predetermined bits is determined by the terminal equipment, the first receiving unit 1201 is further configured to receive the information on the predetermined bits transmitted by the terminal equipment.

In at least one embodiment, the terminal equipment omits the first information of the CSI based on an omit criterion to which the first configuration information corresponds.

Parameters in the omit criterion include:
the number and/or positions of bits to which the omitted first information corresponds; and/or
the number and/or positions of bits to which information reserved in the channel state information corresponds.

In at least one embodiment, the parameters in the omit criterion are predetermined parameters, or are configured by the network device via parameter configuration information.

The omit criterion includes at least one of the following:
omitting former first number of bits in the bit sequence to which the layer corresponds;
omitting latter second number of bits in the bit sequence;
omitting odd bits in the bit sequence first, then omitting even bits in the bit sequence, until a total number of omitted bits is a third number;
omitting even bits in the bit sequence first, then omitting odd bits in the bit sequence, until a total number of omitted bits is fourth number; and
reserving a (P*Q+R)-th bit of the bit sequence, and omitting the remaining bits; where, Q is a positive integer, P is an integer greater than or equal to 0, and R is a positive integer greater than or equal to 1 and less than M.

In at least one embodiment, the omitting occurs in CSI report carried by a physical uplink shared channel (PUSCH) and/or CSI report carried by a physical uplink control channel (PUCCH).

As shown in FIG. 12, the apparatus 1200 further includes a first recovering unit 1202 configured to:
add bits in the first channel state information corresponding to the first information into predetermined contents, so as to obtain the second channel state information; and
decode the second channel state information.

### Embodiments of an Eleventh Aspect

The embodiments of the eleventh aspect of this disclosure provide an apparatus for receiving channel state information (CSI), which is applicable to a network device, and corresponds to the embodiments of the fifth aspect.

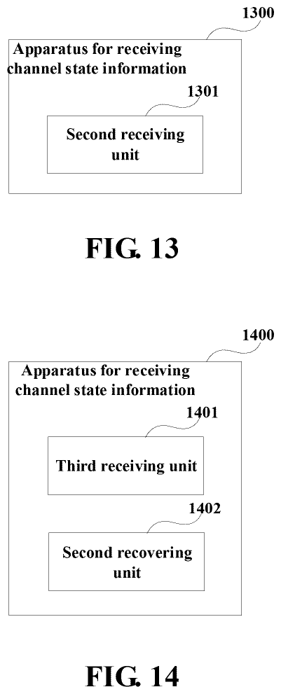

FIG. 13 is a schematic diagram of the apparatus for receiving channel state information of the embodiments of the eleventh aspect. As shown in FIG. 13, an apparatus 1300 includes:
a second receiving unit 1301 configured to receive channel state information (CSI), wherein at least a portion of information of the channel state information is generated based on an artificial intelligence model, the channel state information having priority orders.

The at least a portion of CSI includes two parts, wherein in the two parts,
a first part includes a rank indicator (RI) and/or at least a portion of a channel quality indicator (CQI) and/or a channel state information reference signal resource indicator (CRI), and a second part includes information on a precoding matrix and/or at least a portion of channel quality indicator (CQI) and/or a layer indicator (LI), wherein at least the information on the precoding matrix is generated based on the artificial intelligence model.

In at least one piece of CSI report, the priority orders are set according to information on a layer of the second part and/or information on predetermined bits in the layer.

There may be one or at least two groups of mapping relationships between the priority orders and the information a layer and/or the information on predetermined bits in the layer. In the case where there are at least two groups of mapping relationships, the priority orders of the CSI are set based on one of the at least two groups of mapping relationships. The group of mapping relationships is preset, or is selected by the terminal equipment, or is configured by the network device; wherein in the case where the group of mapping relationships is selected by the terminal equipment, the second receiving unit 1301 is further configured to receive information on the selected group of mapping relationships transmitted by the terminal equipment.

In at least one embodiment, the information on a layer includes an order of the layer, wherein the order of the layer is set according to an arrangement order of an eigenvalue or singular value of a spatial channel matrix to which the layer corresponds. The larger the eigenvalue or singular value, the higher the priority order to which the layer corresponds.

In the CSI report, the second part has one or at least two layers, and in the case where the second part has at least two layers, the layers are generated based on identical artificial intelligence models, or, the at least two layers are generated based on different artificial intelligence models.

In at least one embodiment, the information on predetermined bits includes proportions of the predetermined bits in a bit sequence of the layer, and/or positions of the predetermined bits in the bit sequence.

In the case where the second part of the CSI report has at least two layers,
for different layers, the proportions are identical, or,
for the at least two layers, the proportions are different.

The number of predetermined bits is:
the number of bits obtained by multiplying a total number of bits in the bit sequence of the layer by the proportions and rounding the result.

In at least one embodiment, the information on predetermined bits includes the number of the predetermined bits and/or positions of the predetermined bits in the bit sequence.

In the case where the second part of the CSI report has at least two layers,
for different layers, the numbers of the predetermined bits are identical, or,
for the at least two layers, the numbers of the predetermined bits are different.

In at least one embodiment, the information on predetermined bits is preset information, or, the information on predetermined bits is configured by the network device, or, the information on predetermined bits is determined by the terminal equipment. In the case where the information on predetermined bits is determined by the terminal equipment, the second receiving unit is further configured to receive the information on predetermined bits reported by the terminal equipment.

### Embodiments of a Twelfth Aspect

The embodiments of the twelfth aspect of this disclosure provide an apparatus for receiving channel state information (CSI), which is applicable to a network device, and corresponds to the embodiments of the sixth aspect.

FIG. 14 is a schematic diagram of the apparatus for receiving channel state information of the embodiments of the twelfth aspect. As shown in FIG. 14, an apparatus 1400 includes a third receiving unit 1401, the third receiving unit 1401 being configured to:
receive at least a portion of information of first channel state information (CSI); and
receive indication information, the indication information being used to indicate an expanding mode of the at least a portion of information of first channel state information.

In at least one embodiment, the number and/or positions of bits of a resource used for receiving the indication information is/are predefined, or is/are configured by the network device.

The expanding mode includes: the number of expanded bits, and/or contents of the expanded bits, and/or positions of the expanded bits in the channel state information.

The expanding mode may be at least one of at least two candidate expanding modes, the at least two candidate expanding modes being predefined, or being configured by the network device.

As shown in FIG. 14, the apparatus 1400 further includes:
a second recovering unit 1402 configured to expand the at least a portion of information of the first channel state information based on the expanding mode.

In at least one piece of channel state information report, the at least a portion of the first channel state information has one layer or at least two layers. In the case where the at least a portion of the first CSI has at least two layers, expanding modes of the layers may be identical, or expanding modes of the at least two layers are different. In the case where it has at least two layers, layers with identical expanding modes may share a piece of indication information.

### Embodiments of a Thirteenth Aspect

The embodiments of the thirteenth aspect of this disclosure provide a communication system, including a network device and a terminal equipment.

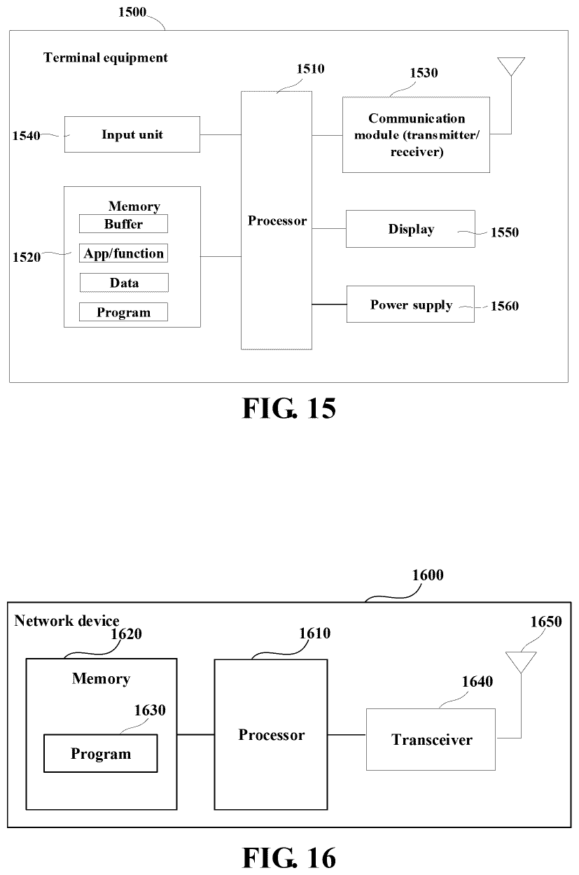

FIG. 15 is a schematic diagram of the terminal equipment of the thirteenth aspect of this disclosure. As shown in FIG. 15, a terminal equipment 1500 (such as the terminal equipment corresponding to FIG. 2) may include a processor 1510 and a memory 1520, the memory 1520 storing data and a program and being coupled to the processor 1510. It should be noted that this figure is illustrative only, and other types of structures may also be used, so as to supplement or replace this structure and achieve a telecommunications function or other functions.

For example, the processor 1510 may be configured to execute a program to carry out the method as described in the embodiments of any of the first to third aspects.

As shown in FIG. 15, the terminal equipment 1500 may further include a communication module 1530, an input unit 1540, a display 1550, and a power supply 1560, wherein functions of the above components are similar to those in the related art, which shall not be described herein any further. It should be noted that the terminal equipment 1500 does not necessarily include all the parts shown in FIG. 15, and the above components are not necessary. Furthermore, the terminal equipment 1500 may include parts not shown in FIG. 15, and the related art may be referred to.

FIG. 16 is a schematic diagram of the network device of the thirteenth aspect of this disclosure. As shown in FIG. 16, a network device 1600 (such as the network device 201 corresponding to FIG. 2) may include a processor 1610 (such as a central processing unit (CPU)) and a memory 1620, the memory 1620 being coupled to the processor 1610. The memory 1620 may store various data, and furthermore, it may store a program 1630 for information processing, and execute the program 1630 under control of the processor 1610.

For example, the processor 1610 may be configured to execute a program to carry out the method described in the embodiments of any one of the fourth to sixth aspects.

Furthermore, as shown in FIG. 16, the network device 1600 may include a transceiver 1640, and an antenna 1650, etc. Functions of the above components are similar to those in the related art, and shall not be described herein any further. It should be noted that the network device 1600 does not necessarily include all the parts shown in FIG. 16, and furthermore, the network device 1600 may include parts not shown in FIG. 16, and the related art may be referred to.

An embodiments of this disclosure provide a computer readable program, which, when executed in a terminal equipment, causes the terminal equipment to carry out the method as described in the embodiments of any one of the first to third aspects.

An embodiments of this disclosure provide a computer storage medium, including a computer readable program, which causes a terminal equipment to carry out the method as described in the embodiments of any one of the first to third aspects.

An embodiments of this disclosure provide a computer readable program, which, when executed in a network device, causes the network device to carry out the method as described in the embodiments of any one of the fourth to sixth aspects.

An embodiments of this disclosure provide a computer storage medium, including a computer readable program, which causes a network device to carry out the method as described in the embodiments of any one of the fourth to sixth aspects.

The above apparatuses and methods of this disclosure may be implemented by hardware, or by hardware in combination with software. This disclosure relates to such a computer-readable program that when the program is executed by a logic device, the logic device is enabled to carry out the apparatus or components as described above, or to carry out the methods or steps as described above. This disclosure also relates to a storage medium for storing the above program, such as a hard disk, a floppy disk, a CD, a DVD, and a flash memory, etc.

The methods/apparatuses described with reference to the embodiments of this disclosure may be directly embodied as hardware, software modules executed by a processor, or a combination thereof. For example, one or more functional block diagrams and/or one or more combinations of the functional block diagrams shown in the drawings may either correspond to software modules of procedures of a computer program, or correspond to hardware modules. Such software modules may respectively correspond to the steps shown in the drawings. And the hardware module, for example, may be carried out by firming the soft modules by using a field programmable gate array (FPGA).

The soft modules may be located in an RAM, a flash memory, an ROM, an EPROM, an EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in the drawings may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of this disclosure. Various variants and modifications may be made by those skilled in the art according to the spirits and principle of this disclosure, and such variants and modifications fall within the scope of this disclosure.

As to implementations containing the above embodiments, following supplements are further disclosed.

An omitting method at a terminal side

1. A method for transmitting channel state information (CSI), applicable to a terminal equipment, the method including:
generating at least a portion of information of channel state information (CSI) according to an artificial intelligence model; and
omitting first information of the CSI according to priority orders of the CSI and/or first configuration information.

2. The method according to supplement 1, wherein,
at least a portion of the CSI includes two parts,
wherein in the two parts,
a first part includes a rank indicator (RI) and/or at least a portion of a channel quality indicator (CQI) and/or a channel state information reference signal resource indicator (CRI),
a second part includes information on a precoding matrix and/or at least a portion of channel quality indicator (CQI) and/or a layer indicator (LI), wherein at least the information on the precoding matrix is generated according to the artificial intelligence model, and the first information is at least a portion of information in the second part.

3. The method according to supplement 2, wherein, the omitting first information of the channel state information according to priority orders includes:
omitting the first information of the channel state information in an ascending order of the priority orders.

4. The method according to supplement 2, wherein,
in at least one piece of CSI report, the priority orders are set according to information on a layer of the second part and/or information on predetermined bits in the layer.

5. The method according to supplement 4, wherein,
there is one or at least two groups of mapping relations between the priority orders and the information on the layers and/or the information on predetermined bits in the layer, in a case where there are at least two groups of mapping relations, the priority orders are set according to one of at least two groups of mapping relations.

5a. The method according to supplement 5, wherein,
the group of mapping relationships is preset, or is selected by the terminal equipment, or is configured by the network device.

5b. The method according to supplement 5, wherein,
in the case where the group of mapping relationships is selected by the terminal equipment,
the terminal equipment receives information on the group of mapping relationships transmitted by the network device, the information instructing the terminal equipment to transmit information on the group of mapping relationships to the network device.

6. The method according to supplement 4, wherein,
the information on the layers includes an order of the layers,
the order of the layers being set according to arrangement orders of eigenvalues or singular values of spatial channel matrices to which the layers correspond.

7. The method according to supplement 6, wherein,
the larger the eigenvalues or singular values, the higher the priority order to which the layer corresponds.

8. The method according to supplement 4, wherein,
in the CSI report, the second part includes one of or at least two of the layers,
and in a case where the second part includes at least two of the layers,
the layers are generated according to identical artificial intelligence models, or the at least two of the layers are generated according to different artificial intelligence models.

9. The method according to supplement 4, wherein,
the information on the predetermined bits includes a proportion of the predetermined bits in a bit sequence of the layers.

10. The method according to supplement 9, wherein,
in the case where the second part of the CSI report has at least two layers,
for different layers, the proportions are identical, or,
for the at least two layers, the proportions are different.

11. The method according to supplement 9, wherein,
the number of the predetermined bits is:
the number of bits obtained by multiplying a total number of bits in the bit sequence of the layer by the proportion and rounding the result.

12. The method according to supplement 9, wherein,
the information on the predetermined bit further includes:
positions of the predetermined bits in the bit sequence.

13. The method according to supplement 4, wherein,
the information on the predetermined bit includes: the number of the predetermined bits.

14. The method according to supplement 13, wherein,
in the case where the second part of the CSI report has at least two layers,
for different layers, the numbers of the predetermined bits are identical; or,
for the at least two layers, the numbers of the predetermined bits are different.

15. The method according to supplement 13, wherein,
the information on predetermined bits further includes:
positions of the predetermined bits in the bit sequence.

16. The method according to supplement 4, wherein,
the information on the predetermined bits is preset information, or
the information on the predetermined bits is configured by the network device, or
the information on the predetermined bits is determined by the terminal equipment.

17. The method according to supplement 16, wherein,
in the case where the information on the predetermined bits is determined by the terminal equipment,
the terminal equipment further reports the information on the predetermined bits to the network device.

18. The method according to supplement 2, wherein,
the terminal equipment omits the first information of the CSI according to an omit criterion to which the first configuration information corresponds.

19. The method according to supplement 18, wherein,
parameters in the omit criterion include:
the number and/or positions of bits to which the omitted first information corresponds; and/or
the number and/or positions of bits to which information reserved in the channel state information corresponds.

20. The method according to supplement 19, wherein,
the parameters in the omit criterion are predetermined parameters, or are obtained by configuring by the network device via parameter configuration information.

21. The method according to supplement 19, wherein,
the omit criterion includes at least one of the following:
omitting former first number of bits in the bit sequence to which the layer corresponds;
omitting latter second number of bits in the bit sequence;
omitting odd bits in the bit sequence first, then omitting even bits in the bit sequence, until a total number of omitted bits is a third number;
omitting even bits in the bit sequence first, then omitting odd bits in the bit sequence, until a total number of omitted bits is fourth number; or
reserving a (P*Q+R)-th bit of the bit sequence, and omitting the remaining bits; where, Q is a positive integer, P is an integer greater than or equal to 0, and R is a positive integer greater than or equal to 1 and less than M.

22. The method according to any one of supplements 1-21, wherein,
the omitting occurs in CSI report carried by a physical uplink shared channel (PUSCH) and/or CSI report carried by a physical uplink control channel (PUCCH).

23. The method according to any one of supplements 1-22, wherein,
the omitted first information is all or a part of the channel state information to which at least one priority reporting level in the priority order corresponds.

A method for determining a priority order at a terminal side

1. A method for transmitting channel state information (CSI), applicable to a terminal equipment, the method including:
generating at least a portion of information of channel state information (CSI) according to an artificial intelligence model,
wherein the CSI has priority orders.

2. The method according to supplement 1, wherein,
the at least a portion of CSI includes two part,
wherein in the two parts,
the first part includes a rank indicator (RI) and/or at least a portion of a channel quality indicator (CQI) and/or a channel state information reference signal resource indicator (CRI),
and the second part includes information on a precoding matrix and/or at least a portion of channel quality indicator (CQI) and/or a layer indicator (LI), wherein at least the information on the precoding matrix is generated according to the artificial intelligence model.

3. The method according to supplement 2, wherein,
in at least one piece of CSI report, the priority orders are set according to information on a layer of the second part and/or information on predetermined bits in the layer.

4. The method according to supplement 3, wherein,
there is/are one or at least two groups of mapping relationships between the priority orders and the information a layer and/or the information on predetermined bits in the layer,
in the case where there are at least two groups of mapping relationships, the priority orders of the CSI is set according to one of the at least two groups of mapping relationships.

4a. The method according to supplement 4, wherein,
the group of mapping relationships is preset, or is selected by the terminal equipment, or is configured by the network device.

4b. The method according to supplement 4, wherein,
in the case where the group of mapping relationships is selected by the terminal equipment,
the terminal equipment transmits information on the selected group of mapping relationships to the network device.

5. The method according to supplement 3, wherein,
the information on a layer includes an order of the layer,
wherein the order of the layer is set according to an arrangement order of an eigenvalue or singular value of a spatial channel matrix to which the layer corresponds.

6. The method according to supplement 5, wherein,
the larger the eigenvalue or singular value, the higher the priority order to which the layer corresponds.

7. The method according to supplement 3, wherein,
in the CSI report, the second part has one or at least two layers,
and in the case where part 2 has at least two layers,
the layers are generated according to identical artificial intelligence models, or, the at least two layers are generated according to different artificial intelligence models.

8. The method according to supplement 3, wherein,
the information on predetermined bits includes proportions of the predetermined bits in a bit sequence of the layer.

9. The method according to supplement 8, wherein,
in the case where the second part of the CSI report has at least two layers,
for different layers, the proportions are identical, or,
for the at least two layers, the proportions are different.

10. The method according to supplement 8, wherein,
the number of predetermined bits is:
the number of bits obtained by multiplying a total number of bits in the bit sequence of the layers by the proportions and rounding an obtained result

11. The method according to supplement 8, wherein,
the information on predetermined bits further includes:
positions of the predetermined bits in the bit sequence.

12. The method according to supplement 3, wherein,
the information on predetermined bits includes: the numbers of the predetermined bits.

13. The method according to supplement 12, wherein,
in the case where the second part of the CSI report has at least two layers,
for different layers, the numbers of the predetermined bits are identical, or,
for the at least two layers, the numbers of the predetermined bits are different.

14. The method according to supplement 12, wherein,
the information on predetermined bits further includes:
positions of the predetermined bits in the bit sequence.

15. The method according to supplement 3, wherein,
the information on predetermined bits is preset information, or,
the information on predetermined bits is configured by the network device, or,
the information on predetermined bits is determined by the terminal equipment.

16. The method according to supplement 15, wherein,
in the case where the information on predetermined bits is determined by the terminal equipment, the terminal equipment further reports the information on predetermined bits to the network device.
   A transmitting method containing indication information at a terminal side

1. A method for transmitting channel state information, applicable to a terminal equipment, the method including:
transmitting at least a portion of information of first channel state information (CSI) by the terminal equipment; and
transmitting indication information by the terminal equipment, the indication information being used to indicate an expanding mode of the at least a portion of information of first channel state information (CSI).

2. The method according to supplement 1, wherein,
the number and/or positions of bits of a resource used for transmitting the indication information is/are predefined, or is/are configured by the network device.

3. The method according to supplement 1, wherein,
the expanding mode includes:
the number of expanded bits, and/or contents of the expanded bits, and/or positions of the expanded bits in the channel state information.

4. The method according to supplement 1, wherein,
the expanding mode is at least one of at least two candidate expanding modes.

5. The method according to supplement 4, wherein,
the at least two candidate expanding modes are predefined, or are configured by the network device.

6. The method according to supplement 1, wherein the method further includes:
performing omitting processing on second channel state information corresponding to the expanding mode by the terminal equipment, so as to form the at least a portion of information of the first channel state information.

7. The method according to supplement 1, wherein,
in at least one piece of channel state information report,
the at least a portion of the first channel state information has one layer or at least two layers,
and in the case where the at least a portion of the first CSI has at least two layers,
expanding modes of the layers are identical, or expanding modes of the at least two layers are different.

8. The method according to supplement 7, wherein,
in the case where there are at least two layers,
layers with identical expanding modes share indication information.
   A method for omitting at a network side

1. A method for receiving channel state information (CSI), applicable to a network device, the method including:
receiving first channel state information (CSI),
wherein the first channel state information is obtained by omitting first information from at least a portion of information of the channel state information (CSI) generated according to an artificial intelligence model according to priority orders of channel state information and/or first configuration information.

2. The method according to supplement 1, wherein,
the at least a portion of the channel state information includes two parts,
wherein in the two parts,
a first part includes a rank indicator (RI) and/or at least a portion of a channel quality indicator (CQI) and/or a channel state information reference signal resource indicator (CRI),
a second part includes information on a precoding matrix and/or at least a portion of channel quality indicator (CQI) and/or a layer indicator (LI), wherein at least the information on the precoding matrix is generated according to the artificial intelligence model,
and the first information is at least a portion of information in the second part.

3. The method according to supplement 2, wherein,
the omitting first information of the channel state information according to priority orders includes:
omitting the first information of the CSI in an ascending order of the priority orders.

4. The method according to supplement 2, wherein,
in at least one piece of CSI report, the priority orders are set according to information on a layer of the second part and/or information on predetermined bits in the layer.

5. The method according to supplement 4, wherein,
there is one or at least two groups of mapping relations between the priority orders and the information on the layers and/or the information on predetermined bits in the layer,
wherein in a case where there are at least two groups of mapping relations, the priority orders are set according to one of at least two groups of mapping relations.

5a. The method according to supplement 5, wherein,
the group of mapping relationships is preset, or is selected by the terminal equipment, or is configured by the network device.

5b. The method according to supplement 5, wherein,
in the case where the group of mapping relationships is selected by the terminal equipment,
the network device receives information on the group of mapping relationships transmitted by the terminal equipment.

6. The method according to supplement 4, wherein,
the information on the layers includes an order of the layers,
the order of the layers being set according to arrangement orders of eigenvalues or singular values of spatial channel matrices to which the layers correspond.

7. The method according to supplement 6, wherein,
the larger the eigenvalues or singular values, the higher the priority order to which the layer corresponds.

8. The method according to supplement 4, wherein,
in the CSI report, the second part includes one of or at least two of the layers,
and in a case where the second part includes at least two of the layers,
the layers are generated according to identical artificial intelligence models, or the at least two of the layers are generated according to different artificial intelligence models.

9. The method according to supplement 4, wherein,
the information on the predetermined bits includes a proportion of the predetermined bits in a bit sequence of the layers.

10. The method according to supplement 9, wherein,
in the case where the second part of the CSI report has at least two layers,
for different layers, the proportions are identical, or,
for the at least two layers, the proportions are different.

11. The method according to supplement 9, wherein,
the number of the predetermined bits is:
the number of bits obtained by multiplying a total number of bits in the bit sequence of the layer by the proportion and rounding the result.

12. The method according to supplement 9, wherein,
the information on the predetermined bit further includes:
positions of the predetermined bits in the bit sequence.

13. The method according to supplement 4, wherein,
the information on the predetermined bit includes:
the number of the predetermined bits.

14. The method according to supplement 13, wherein,
in the case where the second part of the CSI report has at least two layers,
for different layers, the numbers of the predetermined bits are identical; or,
for the at least two layers, the numbers of the predetermined bits are different.

15. The method according to supplement 13, wherein,
the information on predetermined bits further includes:
positions of the predetermined bits in the bit sequence.

16. The method according to supplement 4, wherein,
the information on the predetermined bits is preset information, or
the information on the predetermined bits is configured by the network device, or
the information on the predetermined bits is determined by the terminal equipment.

17. The method according to supplement 16, wherein,
in the case where the information on the predetermined bits is determined by the terminal equipment,
the network device further receives the information on the predetermined bits reported by the terminal equipment.

18. The method according to supplement 2, wherein,
the terminal equipment omits the first information of the CSI according to an omit criterion to which the first configuration information corresponds.

19. The method according to supplement 18, wherein,
parameters in the omit criterion include:
the number and/or positions of bits to which the omitted first information corresponds; and/or
the number and/or positions of bits to which information reserved in the channel state information corresponds.

20. The method according to supplement 19, wherein,
the parameters in the omit criterion are predetermined parameters, or are configured by the network device via parameter configuration information.

21. The method according to supplement 19, wherein,
the omit criterion includes at least one of the following:
omitting former first number of bits in the bit sequence to which the layer corresponds;
omitting latter second number of bits in the bit sequence;
omitting odd bits in the bit sequence first, then omitting even bits in the bit sequence, until a total number of omitted bits is a third number;
omitting even bits in the bit sequence first, then omitting odd bits in the bit sequence, until a total number of omitted bits is fourth number; or
reserving a (P*Q+R)-th bit of the bit sequence, and omitting the remaining bits; where, Q is a positive integer, P is an integer greater than or equal to 0, and R is a positive integer greater than or equal to 1 and less than M.

22. The method according to any one of supplements 1-21, wherein,
the omitting occurs in CSI report carried by a physical uplink shared channel (PUSCH) and/or CSI report carried by a physical uplink control channel (PUCCH).

23. The method according to any one of supplements 1-22, wherein the method further includes:
adding bits in the first channel state information corresponding to the first information into predetermined contents by the network device, so as to obtain the second channel state information; and
decoding the second channel state information by the network device.

24. The method according to any one of supplements 1-23, wherein,
the omitted first information is all or a portion of the channel state information to which at least one priority reporting level in the priority orders corresponds.
   A method of priority order at a network side

1. A method for receiving channel state information (CSI), applicable to a network device, the method including:
receiving channel state information (CSI),
wherein at least a portion of information of the channel state information is generated according to an artificial intelligence model,
the channel state information having priority orders.

2. The method according to supplement 1, wherein,
the at least a portion of CSI includes two parts,
wherein in the two parts,
a first part includes a rank indicator (RI) and/or at least a portion of a channel quality indicator (CQI) and/or a channel state information reference signal resource indicator (CRI),
and the second part includes information on a precoding matrix and/or at least a portion of channel quality indicator (CQI) and/or a layer indicator (LI), wherein at least the information on the precoding matrix is generated according to the artificial intelligence model.

3. The method according to supplement 2, wherein,
in at least one piece of CSI report, the priority orders is set according to information on a layer of the second part and/or information on predetermined bits in the layer.

4. The method according to supplement 3, wherein,
there is one or at least two groups of mapping relationships between the priority orders and the information a layer and/or the information on predetermined bits in the layer,
in the case where there are at least two groups of mapping relationships, the priority orders of the CSI may be set according to one of the at least two groups of mapping relationships.

4a. The method according to supplement 4, wherein,
the group of mapping relationships is preset, or is selected by the terminal equipment, or is configured by the network device.

4b. The method according to supplement 4, wherein,
in the case where the group of mapping relationships is selected by the terminal equipment,
the network device receives information on the selected group of mapping relationships transmitted by the terminal equipment.

5. The method according to supplement 3, wherein,
the information on a layer includes an order of the layer,
wherein the order of the layer is set according to an arrangement order of an eigenvalue or singular value of a spatial channel matrix to which the layer corresponds.

6. The method according to supplement 5, wherein,
the larger the eigenvalue or singular value, the higher the priority order to which the layer corresponds.

7. The method according to supplement 3, wherein,
in the CSI report, the second part has one or at least two layers,
and in the case where part 2 has at least two layers,
the layers are generated according to identical artificial intelligence models, or, the at least two layers are generated according to different artificial intelligence models.

8. The method according to supplement 3, wherein,
the information on predetermined bits includes: proportions of the predetermined bits in a bit sequence of the layer.

9. The method according to supplement 8, wherein,
in the case where the second part of the CSI report has at least two layers,
for different layers, the proportions are identical, or,
for the at least two layers, the proportions are different.

10. The method according to supplement 8, wherein,
the number of predetermined bits is:
the number of bits obtained by multiplying a total number of bits in the bit sequence of the layer by the proportions and rounding the result.

11. The method according to supplement 3, wherein,
the information on predetermined bits further includes:
positions of the predetermined bits in the bit sequence.

12. The method according to supplement 3, wherein,
the information on predetermined bits includes: the number of the predetermined bits.

13. The method according to supplement 12, wherein,
in the case where the second part of the CSI report has at least two layers,
for different layers, the numbers of the predetermined bits are identical, or,
for the at least two layers, the numbers of the predetermined bits are different.

14. The method according to supplement 12, wherein,
the information on predetermined bits further includes:
positions of the predetermined bits in the bit sequence.

15. The method according to supplement 3, wherein,
the information on predetermined bits is preset information, or,
the information on predetermined bits is configured by the network device, or,
the information on predetermined bits is determined by the terminal equipment.

16. The method according to supplement 15, wherein,
in the case where the information on predetermined bits is determined by the terminal equipment,
the network device further receives the information on predetermined bits reported by the terminal equipment.
   A receiving method containing indication information at a network side

1. A method for receiving channel state information, applicable to a network device, the method including:
receiving at least a portion of information of first channel state information (CSI) by the network device; and
receiving indication information by the network device, the indication information being used to indicate an expanding mode of the at least a portion of information of first channel state information.

2. The method according to supplement 1, wherein,
the number and/or positions of bits of a resource used for receiving the indication information is/are predefined, or is/are configured by the network device.

3. The method according to supplement 1, wherein,
the expanding mode includes:
the number of expanded bits, and/or contents of the expanded bits, and/or positions of the expanded bits in the channel state information.

4. The method according to supplement 1, wherein,
the expanding mode is at least one of at least two candidate expanding modes.

5. The method according to supplement 4, wherein,
the at least two candidate expanding modes are predefined, or are configured by the network device.

6. The method according to supplement 1, wherein the method further includes:
expanding the at least a portion of information of the first channel state information by the network device according to the expanding mode.

7. The method according to supplement 1, wherein,
in at least one piece of channel state information report,
the at least a portion of the first channel state information has one layer or at least two layers,
and in the case where the at least a portion of the first CSI has at least two layers,
expanding modes of the layers are identical, or expanding modes of the at least two layers are different.

8. The method according to supplement 7, wherein,
in the case where the at least a portion of the first CSI has at least two layers, layers with identical expanding modes share a piece of indication information.

What is claimed is:

1. An apparatus for transmitting channel state information (CSI), applicable to a terminal equipment, the apparatus comprising:
a first generator configured to generate at least a portion of information of channel state information (CSI) according to an artificial intelligence model; and
first omitting processor circuitry configured to omit first information of the channel state information according to priority orders of the channel state information and/or first configuration information.

2. The apparatus according to claim 1, wherein,
at least a portion of the channel state information comprises two parts,
wherein the two parts comprises:
a first part comprises a rank indicator (RI) and/or at least a portion of a channel quality indicator (CQI) and/or a channel state information reference signal resource indicator (CRI),
a second part comprises information on a precoding matrix and/or at least a portion of channel quality indicator (CQI) and/or a layer indicator (LI), wherein at least the information on the precoding matrix is generated based on the artificial intelligence model, and
the first information is at least a portion of information in the second part.

3. The apparatus according to claim 2, wherein,
the first omitting processor circuitry omits the first information of the channel state information in an ascending order of the priority orders; and/or
in at least one piece of channel state information report, the priority orders are set according to information on a layer of the second part and/or information on predetermined bits in the layer.

4. The apparatus according to claim 3, wherein,
there is/are one or at least two groups of mapping relations between the priority orders and the information on the layer and/or the information on predetermined bits in the layer,
and in a case where there are at least two groups of mapping relations, the priority orders are set according to one of at least two groups of mapping relations; and/or
the information on the layer comprises an order of the layer, the order of the layer being set according to arrangement orders of eigenvalues or singular values of spatial channel matrices to which the layers correspond; and/or
in the channel state information report, the second part comprises one of or at least two of the layers,
and in a case where the second part comprises at least two of the layers,
the layers are generated according to identical artificial intelligence models, or the at least two of the layers are generated according to different artificial intelligence models; and/or
the information on the predetermined bits comprises at least one of the following: a proportion of the predetermined bits in a bit sequence of the layers, the number of the predetermined bits, or positions of the predetermined bits in the bit sequence; and/or
the information on the predetermined bits is preset information, or the information on the predetermined bits is configured by a network device, or the information on the predetermined bits is determined by the terminal equipment.

5. The apparatus according to claim 4, wherein,
the one group of mapping relations is preset, or is selected by the terminal equipment, or is configured by the network device; and/or
in a case where the terminal equipment selects the one group of mapping relations,
the apparatus is configured to receive information transmitted by the network device, the information instructing the apparatus to transmit information on the one group of mapping relations to the network device.

6. The apparatus according to claim 4, wherein,
in a case where the second part of the channel state information report comprises at least two of the layers,
the proportions are equal for different layers, or the proportions are unequal for at least two of the layers; and/or
the number of predetermined bits is that: the number of bits obtained by multiplying a total number of bits in the bit sequence of the layers by the proportions and rounding a product or an obtained result;
and/or,
in a case where the second part of the channel state information report comprises at least two of the layers,
for different layers, the numbers of the predetermined bits are identical; or, for at least two of the layers, the numbers of the predetermined bits are different.

7. The apparatus according to claim 2, wherein,
the first omitting processor circuitry is configured to omit the first information of the channel state information based on an omit criterion to which the first configuration information corresponds.

8. The apparatus according to claim 7, wherein,
parameters in the omit criterion comprise:
the number and/or positions of bits to which the omitted first information corresponds; and/or
the number and/or positions of bits to which information reserved in the channel state information corresponds.

9. The apparatus according to claim 8, wherein,
the parameters in the omit criterion are predetermined parameters, or are obtained by configuring by the network device through parameter configuration information; and/or
the omit criterion comprises at least one of the following:
omitting a former first number of bits in a bit sequence to which the layer of the second part corresponds;
omitting a latter second number of bits in the bit sequence;
omitting odd bits in the bit sequence first, and then omitting even bits in the bit sequence, until a total number of omitted bits is a third number;
omitting even bits in the bit sequence first, and then omitting odd bits in the bit sequence, until a total number of omitted bits is a fourth number; or
maintaining a (P*Q+R)-th bit in the bit sequence, and omitting the remaining bits; where, Q is a positive integer, P is an integer greater than or equal to 0, and R is a positive integer greater than or equal to 1 and less than Q.

10. The apparatus according to claim 1, wherein,
the omitted first information is all or a portion of the channel state information to which at least one priority reporting level in the priority orders corresponds.

11. An apparatus for transmitting channel state information (CSI), applicable to a terminal equipment, the apparatus comprising:
a second generator configured to generate at least a portion of information of channel state information (CSI) based on an artificial intelligence model,
wherein the channel state information has priority orders.

12. The apparatus according to claim 11, wherein,
the at least a portion of information of channel state information comprises two parts,
wherein in the two parts,
a first part comprises a rank indicator (RI) and/or at least a portion of a channel quality indicator (CQI) and/or a channel state information reference signal resource indicator (CRI),
and a second part comprises information on a precoding matrix and/or at least a portion of channel quality indicator (CQI) and/or a layer indicator (LI), wherein at least the information on the precoding matrix is generated based on the artificial intelligence model.

13. The apparatus according to claim 12, wherein,
in at least one piece of channel state information report, the priority orders are set according to information on a layer of the second part and/or information on predetermined bits in the layer.

14. An apparatus for receiving channel state information (CSI), applicable to a network device, the apparatus comprising:
a first receiver configured to receive first channel state information (CSI),
wherein the first channel state information is obtained by omitting first information from at least a portion of the channel state information (CSI) generated according to an artificial intelligence model according to priority orders of channel state information and/or first configuration information.

15. The apparatus according to claim 14, wherein,
the at least a portion of the channel state information comprises two parts,
wherein in the two parts,
a first part comprises a rank indicator (RI) and/or at least a portion of a channel quality indicator (CQI) and/or a channel state information reference signal resource indicator (CRI),
a second part comprises information on a precoding matrix and/or at least a portion of channel quality indicator (CQI) and/or a layer indicator (LI), wherein at least the information on in the precoding matrix is generated according to the artificial intelligence model,
and the first information is at least a portion of information in the second part.

16. The apparatus according to claim 15, wherein,
the omitting first information of the channel state information according to priority orders comprises: omitting the first information of the channel state information in an ascending order of the priority orders;
and/or
in at least one piece of channel state information report, the priority orders are set according to information on a layer of the second part and/or information on predetermined bits in the layer.

17. The apparatus according to claim 16, wherein,
there is one or at least two groups of mapping relations between the priority orders and the information on the layers and/or the information on predetermined bits in the layer,
and in a case where there are at least two groups of mapping relations, the priority orders are set according to one of at least two groups of mapping relations; and/or
the information on the layers comprises an order of the layers,
the order of the layers being set according to arrangement orders of eigenvalues or singular values of spatial channel matrices to which the layers correspond; and/or
in the channel state information report, the second part comprises one of or at least two of the layers,
and in a case where the second part comprises at least two of the layers,
the layers are generated according to identical artificial intelligence models, or the at least two of the layers are generated according to different artificial intelligence models; and/or
the information on the predetermined bits comprises at least one of the following: a proportion of the predetermined bits in a bit sequence of the layers, positions of the predetermined bits in the bit sequence, and the number of the predetermined bits; and/or
the information on the predetermined bits is preset information, or the information on the predetermined bits is configured by the network device, or the information on the predetermined bits is determined by a terminal equipment.

18. The apparatus according to claim 17, wherein,
the one group of mapping relations is preset, or is selected by the terminal equipment, or is configured by the network device.

19. The apparatus according to claim 15, wherein,
the terminal equipment omits the first information of the channel state information according to an omit criterion to which the first configuration information corresponds.

20. The apparatus according to claim 19, wherein,
parameters in the omit criterion comprise:
the number and/or positions of bits to which the omitted first information corresponds; and/or
the number and/or positions of bits to which information reserved in the channel state information corresponds.
